(19) United States
(12) Patent Application Publication
(10) Pub. No.: US 2020/0118343 A1
(43) Pub. Date: Apr. 16, 2020

(54) METHODS, SYSTEMS AND DEVICES SUPPORTING REAL-TIME INTERACTIONS IN AUGMENTED REALITY ENVIRONMENTS

(71) Applicant: WITHIN UNLIMITED, INC., LOS ANGELES, CA (US)

(72) Inventors: Aaron KOBLIN, Venice, CA (US); Chris MILK, LOS ANGELES, CA (US)

(21) Appl. No.: 16/675,196

(22) Filed: Nov. 5, 2019

Related U.S. Application Data
(63) Continuation of application No. PCT/IB2018/052882, filed on Apr. 26, 2018.
(60) Provisional application No. 62/503,826, filed on May 9, 2017.
(60) Provisional application No. 62/503,868, filed on May 9, 2017.
(60) Provisional application No. 62/513,208, filed on May 31, 2017.
(60) Provisional application No. 62/515,419, filed on Jun. 5, 2017.
(60) Provisional application No. 62/618,388, filed on Jan. 17, 2018.

(51) Int. Cl. G06T 19/00; G06F 3/01; G06T 13/40; G06K 9/00; G06T 13/80

(52) U.S. Cl. CPC G06T 19/006; G06F 3/017; G06F 3/012; H04N 5/247; G06K 9/00221; G06T 13/80; G06T 2215/16; G06T 13/40

(57) ABSTRACT

A communication method includes obtaining a first image from a first camera associated with a first device, the first image comprising live view of a first real-world, physical environment; for each particular second device of one or more second devices, obtaining, from the particular second device, a particular second image, the particular second image being based on a real view of a user of the particular second device; creating an augmented image based on (i) the first image, and (ii) each particular second image obtained in (B); and rendering the augmented image on a display associated with the first device.

### CROSS-REFERENCE TO RELATED APPLICATIONS

This application is a continuation of PCT/IB2018/052882, filed Apr. 26, 2018, the entire contents of which are hereby fully incorporated herein by reference for all purposes. PCT/IB2018/052882 claims priority from U.S. Provisional Applications (i) No. 62/503,868, filed May 9, 2017, (ii) No. 62/503,826, filed May 9, 2017, (iii) No. 62/513,208, filed May 31, 2017, (iv) No. 62/515,419, filed Jun. 5, 2017, and (v) No. 62/618,388, filed Jan. 17, 2018, the entire contents of all of which is hereby fully incorporated herein by reference for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates generally to augmented reality (AR), and, more particularly, to methods, systems and devices supporting real-time interactions in AR environments.

### SUMMARY

The present invention is specified in the claims as well as in the below description. Preferred embodiments are particularly specified in the dependent claims and the description of various embodiments.

A skilled reader will understand, that any method described above or below and/or claimed and described as a sequence of steps or acts is not restrictive in the sense of the order of steps or acts.

Below is a list of method or process embodiments. Those will be indicated with a letter “M”. Whenever such embodiments are referred to, this will be done by referring to “M” embodiments.

### Embodiment M1

A communication method comprising:
   (A) obtaining a first image from a first camera associated with a first device, the first image comprising live view of a first real-world, physical environment;
   (B) for each particular second device of one or more second devices,
   (b)(1) obtaining, from the particular second device, a particular second image, the particular second image being based on a live view of a user of the particular second device;
   (C) creating an augmented image based on (i) the first image, and (ii) at least one particular second image obtained in (B); and
   (D) rendering the augmented image on a display associated with the first device.
M2. The method of embodiment M1, wherein the one or more second devices comprise a single second device.
M3. The method of embodiment M1, wherein the one or more second devices comprise multiple second devices.
M4. The method of any one of the preceding embodiments, further comprising, at the first device:
   (E) obtaining a user image from a second camera associated with the first device; and
   (F) providing a version of the user image to at least some of the one or more second devices.
M5. The method of any one of the preceding embodiments further comprising:
   (G) for at least one particular second device of one or more second devices,
   (g)(1) obtaining, from the at least one particular second device, particular audio data; and
   (H) rendering audio on a speaker associated with the first device, the audio being based on the particular audio data obtained in (G).
M6. The method of embodiment M5, wherein the particular audio data comprises a recording of speech from the user of the at least one particular second device.
M7. The method of embodiments M5 or M6, wherein the audio rendered in (H) is manipulated and/or augmented before being rendered.
M8. The method of any one of embodiments M5-M7 wherein at least some audio data received from the one or more second devices was manipulated and/or augmented before being sent to the first device.
M9. The method of any one of the preceding embodiments further comprising, at the first device:
   (I) capturing audio data;
   (J) providing a version of the audio data captured in (I) to the one or more second devices.
M10. The method of embodiment M9, wherein the version of the audio data provided in (J) is manipulated and/or augmented audio data.
M11. The method of any one of the preceding embodiments, further comprising, at the first device:
   (K) capturing a user image from a second camera associated with the first device; and
   (L) providing a version of the user image to the one or more second devices.
M12. The method of embodiment MK further comprising:
   (M) manipulating the user image before providing it to one or more second devices, wherein the version of the user image provided to the one or more second devices comprises a modified version of the captured user image.
M13. The method of embodiment M12, wherein the modified version of the captured user image comprises a modified and/or animated image of at least a portion of the user's face.
M14. The method of embodiments M12 or M13, wherein the manipulating the image comprises animating at least a portion of the image.
M15. The method of embodiment M14, wherein the portion of the image comprises the user's face.
M16. The method of any one of embodiments M13-M15, further comprising: recognizing the user's face in the first image.
M17. The method of any one of embodiments M13-M16, further comprising: tracking the user's face in real-time.
M18. The method of any one of embodiments M14-M17, wherein the animating is based on real-time tracking of the user's face.
M19. The method of any one of the preceding embodiments, wherein creating the augmented image in (C) comprises: adding information to the augmented image.
M20. The method of embodiment M19, wherein the information added to the image comprises one or more of: virtual information, and text information.
M21. The method of embodiment M20, wherein the text information comprises one or more of: captions, voice-to-speech text, annotations, and labels.
M22. The method of any one of the preceding embodiments, wherein the first camera is a rear-facing camera of the first device and the second camera is a front-facing camera of the first device.

### Embodiment M23

A communication method comprising:
   (A) obtaining a first image from a first camera associated with a first device, the first image comprising live view of a first real-world, physical environment;
   (B) obtaining a second image from a second device in communication with the first device, the second image being based on a real view of a user of the second device;
   (C) creating an augmented image based on the first image and the second image; and
   (D) rendering the augmented image on a display associated with the first device.
M24. The method of embodiment M23, wherein creating the augmented image in (C) comprises: animating at least a portion of the second image.
M25. The method of embodiment M24, wherein at least the portion of the second image is animated using the second device.
M26. The method of embodiments M24 or M25, wherein at least the portion of the second image is animated, at least in part, by manipulation and/or movement of the second device.
M27. The method of any one of embodiments M24-M26, wherein movement of at least the portion of the second image corresponds, at least in part, to movement of the second device.
M28. The method of any one of embodiments M23-M27, wherein creating the augmented image in (C) comprises: adding information to the augmented image.
M29. The method of embodiment M28, wherein the information added to the augmented image comprises one or more of: virtual information, and text information.
M30. The method of embodiment M29, wherein the text information comprises one or more of: captions, voice-to-speech text, annotations, and labels.
M31. The method of any one of embodiments M23-M30, further comprising:
   (E) rendering audio on a speaker associated with the first device, the audio being based on audio data from the second device.
M32. The method of embodiment M28, wherein the audio data from the second device comprises a recording of speech from the user of the second device.
M33. The method of embodiments M31 or M32, wherein the audio rendered in (E) is manipulated and/or augmented before being rendered.
M34. The method of any one of embodiments M31 to M33, wherein the audio data from the second device was manipulated and/or augmented before being sent to the first device.
M35. The method of any one of embodiments M23-M34, further comprising, at the first device:
   (F) capturing a user image from a second camera associated with the first device;
   (G) capturing audio data;
   (H) providing, to the second device, a version of the user image and a version of the audio data,
   wherein the first camera is a rear-facing camera of the first device and the second camera is a front-facing camera of the first device.
M36. The method of embodiment M35, further comprising:
   (I) manipulating the user image before providing the version of the user image to the second device, wherein the version of the user image provided to the second device is a modified version of the user image captured in (F).
M37. The method of embodiment M36, wherein the modified version of the captured user image comprises a portion of the user's face.
M38. The method of embodiments M36 or M37, wherein the manipulating the user image comprises animating at least a portion of the user image.
M39. The method of embodiment M38, wherein the animating is based on real-time tracking of the user's face.
M40. The method of any one of embodiments M38 or M39, wherein at least the portion of the user image is animated, at least in part, by manipulation and/or movement of the second device.
M41. The method of any one of embodiments M23-M40, wherein at least a portion of the second image is animated.
M42. The method of embodiment M41, wherein at least the portion of the second image is animated using the second device.
M43. The method of embodiments M41 or M42, wherein at least the portion of the second image is animated, at least in part, by manipulation and/or movement of the second device.
M44. The method of any one of embodiments M23-M43, wherein the second image comprises an animated version of a portion of the real view of the user of the second device.
M45. The method of any one of embodiments M23-M43, wherein the second image comprises an animated image based on a portion of the real view of the user of the second device.
M46. The method of any one of embodiments M23-M45, wherein the second image comprises a virtual object.
M47. The method of embodiment M46, wherein the virtual object corresponds to the second device.
M48. The method of embodiments M46 or M47, wherein the virtual object is animated or moves within the second image, and wherein animation or movement of the virtual object in the second image corresponds to the movement of second device.
M49. The method of any one of embodiments M31 to M48, further comprising:
   (J) modifying the audio data before sending it to the second device, wherein the version of the audio sent to the second device is a modified version of the captured audio data.
M50. The method of any one of embodiments M23-M49, wherein the augmented image created in (C) is also based on a story, the story comprising a plurality of events, each of the events comprising one or more of: (i) audio information; (ii) textual information; and (iii) augmented reality (AR) information, and wherein the rendering in (D) comprises: rendering one or more of: (x) audio information associated with the event; (y) textual information associated with the event; and (z) AR information associated with the event.
M51. The method of any one of the preceding embodiments, wherein the first device is a mobile phone or a tablet device.
M52. The method of any one of the preceding embodiments, wherein the first image and each particular second image from the one or more second devices comprise a unified space, and wherein the augmented image provides a view of the unified space.

### Embodiment M53

A method, with a device having at least one camera and a display, the method comprising:
   (A) capturing a scene with the at least one camera, the scene comprising a live view of a real-world physical environment;
   (B) for a story comprising a plurality of events,
   (B)(1) rendering a particular event of the plurality of events on the display, wherein the rendering of the event augments the scene captured in (A) by the at least one camera.
M54. The method of embodiment M53, further comprising: (B)(2) transitioning to a next event of the plurality of events.
M55. The method of embodiment M54, further comprising: (B)(3) in response to the transitioning in (B)(2), rendering the next event of the plurality of events on the display.
M56. The method of any one of embodiments M53-M55, wherein the particular event includes event transition information, and wherein the transitioning in (B)(2) occurs in accordance with the event transition information.
M57. The method of any one of embodiments M53-M56, wherein the transition is based on one or more of:
   (a) a period of time;
   (b) a user interaction; and
   (c) a user gesture.
M58. The method of embodiment M57, wherein the user gesture is determined based on an image obtained by the device.
M59. The method of embodiment M57, wherein the user gesture is determined based on movement and/or orientation of the device.
M60. The method of embodiments M58 or M59, wherein the user gesture comprises a facial gesture and/or a body gesture.
M61. The method of any one of embodiments M57-M60, wherein the user interaction comprises one or more of: a user voice command; and a user touching a screen or button on the device.
M62. The method of any one of embodiments M53-M61, wherein the particular event comprises one or more of: (i) audio information; (ii) textual information; and (iii) augmented reality (AR) information, and wherein rendering of the particular event in (B)(1) comprises rendering one or more of: (x) audio information associated with the event; (y) textual information associated with the event; and (z) AR information associated with the event.
M63. The method of any one of embodiments M53-M62, further comprising: repeating act (B)(1) for multiple events in the story.
M64. The method of any one of embodiments M53-M63, wherein the at least one camera and the display are integrated in the device.
M65. The method of any one of embodiments M53-M64, wherein the first device is a mobile phone or a tablet device.
M66. The method of any one of embodiments M53-M65, further comprising:
   (C) obtaining a user image from at least one second camera; and
   (D) rendering, on the display, a version of the user image with the particular event of the plurality of events in (B)(1).
M67. The method of embodiment M66, wherein rendering a version of the user image in (D) comprises: animating at least a portion of the user image.
M68. The method of embodiment M67, wherein the portion of the image comprises the user's face.
M69. The method of any one of embodiments M66-M68, further comprising: recognizing the user's face in the user image.
M70. The method of any one of embodiments M68-M69, further comprising: tracking the user's face in real-time.
M71. The method of any one of embodiments M66-M70, wherein the rendering in (C) is based on real time tracking of the user's face in the user image.
M72. The method of any one of embodiments M67-M71, wherein the at least one second camera is associated with a second device, and wherein the animating is based, at least in part, on manipulation and/or movement of the second device.
M73. The method of embodiment M72, wherein the second device comprises a mobile phone or a tablet device.
M74. The method of any one of embodiments M53-M73, further comprising:
   (E) capturing audio data from the device; and
   (F) rendering a version of the captured audio with the particular event of the plurality of events in (B)(1) on at least one speaker associated with the device. M75. The method of embodiment M74, wherein the audio rendered in (F) is manipulated and/or augmented before being rendered.
M76. The method of any one of embodiments M53-M75, wherein the at least one second camera is associated with the device.
M77. The method of any one of embodiments M53-M76, wherein the at least one second camera is associated with another device, distinct from the device.
M78. The method of any one of embodiments M54-M77, wherein the transitioning in (B)(2) is based on an action associated with another device.
M79. The method of embodiment M78, wherein the transitioning in (B)(2) is triggered by the action associated with the other device.

### Embodiment M80

A method comprising:
   (A) capturing a scene from a first camera associated with a first device having a first display, the scene comprising a live view of a real-world physical environment;
   (B) for a story comprising a plurality of events,
   (B)(1) rendering a particular event of the plurality of events on the first display, wherein the rendering of the event augments the scene captured by the first camera; and
   (B)(2) transitioning to a next event of the plurality of events.
M81. The method of embodiment M80, wherein the rendering of the event also augments the scene with information associated with at least one other device.
M82. The method of embodiment M81, wherein the information associated with the at least one other device corresponds to on one or more of:
   (i) an image captured by the at least one other device; and
   (ii) an image representing or corresponding to the at least one other device.
M83. The method of embodiments M81 or M82, wherein the information associated with the at least one other device corresponds to on one or more of: (iii) audio from the at least one other device.
M84. The method of embodiments M82 or M83, wherein the image representing or corresponding to the at least one other device comprises an avatar.
M85. The method of embodiments M82-M84, wherein the image representing or corresponding to the at least one other device is animated.
M86. The method of embodiment M85, wherein the image is animated, at least in part, by manipulation and/or movement of the at least one other device.
M87. The method of any one of embodiments M80-M87, wherein the particular event includes event transition information, and wherein the transitioning in (B)(2) occurs in accordance with the event transition information.
M88. The method of any one of embodiments M80-M88, wherein the transitioning in (B)(2) occurs based on an action associated with the at least one other device.
M89. The method of embodiment M88, wherein the transitioning in (B)(2) is triggered by the action associated with the other device.
M90. The method of any one of embodiments M80-M89, wherein the captured scene comprises a unified space, and wherein the rendered particular event provides a view of the unified space.

### Embodiment M91

A communication method comprising:
   (A) obtaining a plurality of images from a first camera associated with a first device, the plurality of images comprising live views of a first real-world, physical environment;
   (B) using the plurality of images to create a modeled space of the first real-world physical environment;
   (C) providing the modeled space to a second device in communication with the first device;
   (D) correlating a real-world location of the user of the second device with a corresponding virtual location within the modeled space;
   wherein changes in the real-world location of the user of the second device result in corresponding changes of the virtual location within the modeled space.

The above features along with additional details of the invention, are described further in the examples herein, which are intended to further illustrate the invention but are not intended to limit its scope in any way.

### BRIEF DESCRIPTION OF THE DRAWINGS

Objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification.

FIGS. 1A-1E depict aspects of a typical device according to exemplary embodiments hereof;

FIG. 2A depicts aspects of components a device according to exemplary embodiments hereof;

FIG. 2B show aspects of a backend platform according to exemplary embodiments hereof;

FIGS. 3-4 show aspects of examples of communication according to exemplary embodiments hereof;

FIGS. 5A-5E are flowcharts showing aspects of exemplary flow according to exemplary embodiments hereof;

FIGS. 6-8 shows aspects of an example of communication according to exemplary embodiments hereof;

FIGS. 8A-8D show aspects of image animation and manipulation according to exemplary embodiments hereof;

FIG. 9 is a flowchart showing aspects of exemplary flow according to exemplary embodiments hereof;

FIG. 9B shows aspects of a unified virtual space according to exemplary embodiments hereof;

FIGS. 10A-10B show aspects of exemplary storytelling embodiments hereof;

FIGS. 11A-11B depict data structures of a story according to exemplary embodiments hereof;

FIGS. 12A-12D are screenshots showing aspects of examples of exemplary storytelling embodiments hereof;

FIGS. 13A-13B are flowcharts showing aspects of exemplary flow according to exemplary embodiments hereof;

FIG. 14 shows aspects of a unified virtual story space according to exemplary embodiments hereof;

FIGS. 15 and 16 show aspects of examples according to exemplary embodiments hereof; and

FIG. 17 is a logical block diagram depicting aspects of a computer system.

### DETAILED DESCRIPTION OF THE PRESENTLY PREFERRED EXEMPLARY EMBODIMENTS

### Glossary and Abbreviations

As used herein, unless used otherwise, the following terms or abbreviations have the following meanings:

“2D” or “2-D” means two-dimensional;

“3D” or “3-D” means three-dimensional;

“AR” means augmented reality.

“VR” means virtual reality.

A “mechanism” refers to any device(s), process(es), routine(s), service(s), or combination thereof. A mechanism may be implemented in hardware, software, firmware, using a special-purpose device, or any combination thereof. A mechanism may be integrated into a single device or it may be distributed over multiple devices. The various components of a mechanism may be co-located or distributed. The mechanism may be formed from other mechanisms. In general, as used herein, the term “mechanism” may thus be considered to be shorthand for the term device(s) and/or process(es) and/or service(s).

### DESCRIPTION

In the following, exemplary embodiments of the invention will be described, referring to the figures. These examples are provided to provide further understanding of the invention, without limiting its scope.

In the following description, a series of features and/or steps are described. The skilled person will appreciate that unless required by the context, the order of features and steps is not critical for the resulting configuration and its effect. Further, it will be apparent to the skilled person that irrespective of the order of features and steps, the presence or absence of time delay between steps, can be present between some or all of the described steps.

It will be appreciated that variations to the foregoing embodiments of the invention can be made while still falling within the scope of the invention. Alternative features serving the same, equivalent or similar purpose can replace features disclosed in the specification, unless stated otherwise. Thus, unless stated otherwise, each feature disclosed represents one example of a generic series of equivalent or similar features.

Devices

Smartphones and other such portable computing devices are ubiquitous, and much of today's communication takes place via such devices. With current devices, users may interact and converse in real time using various computer and/or telephone networks. In addition, many young children use such devices for reading, playing games, and sometimes even communication.

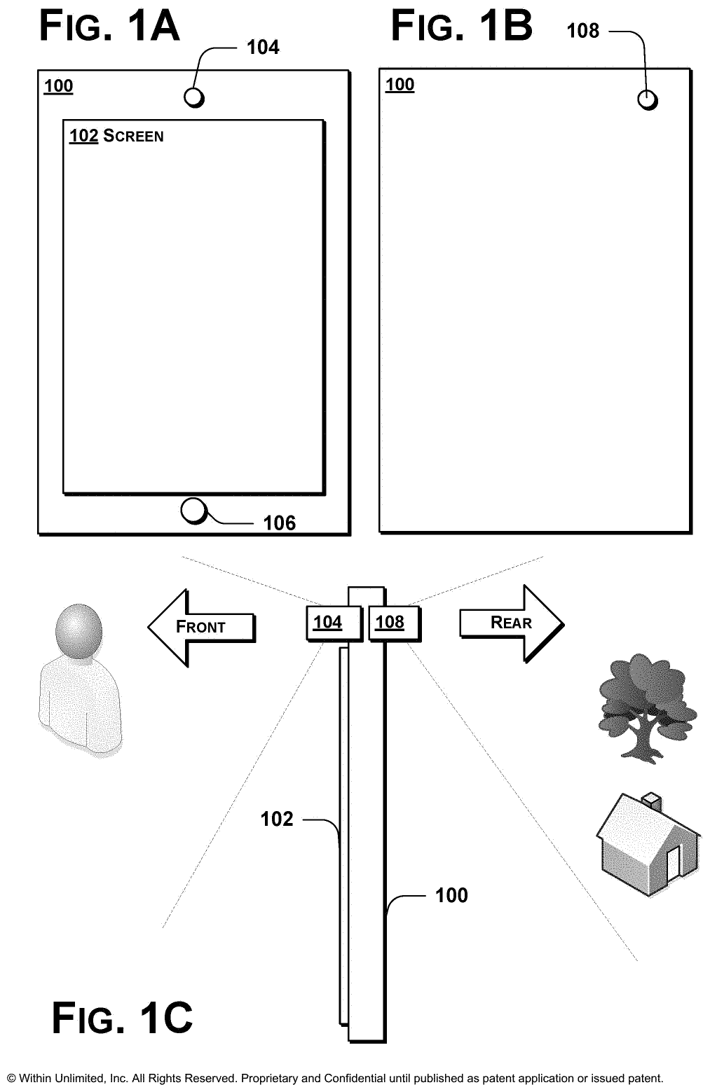

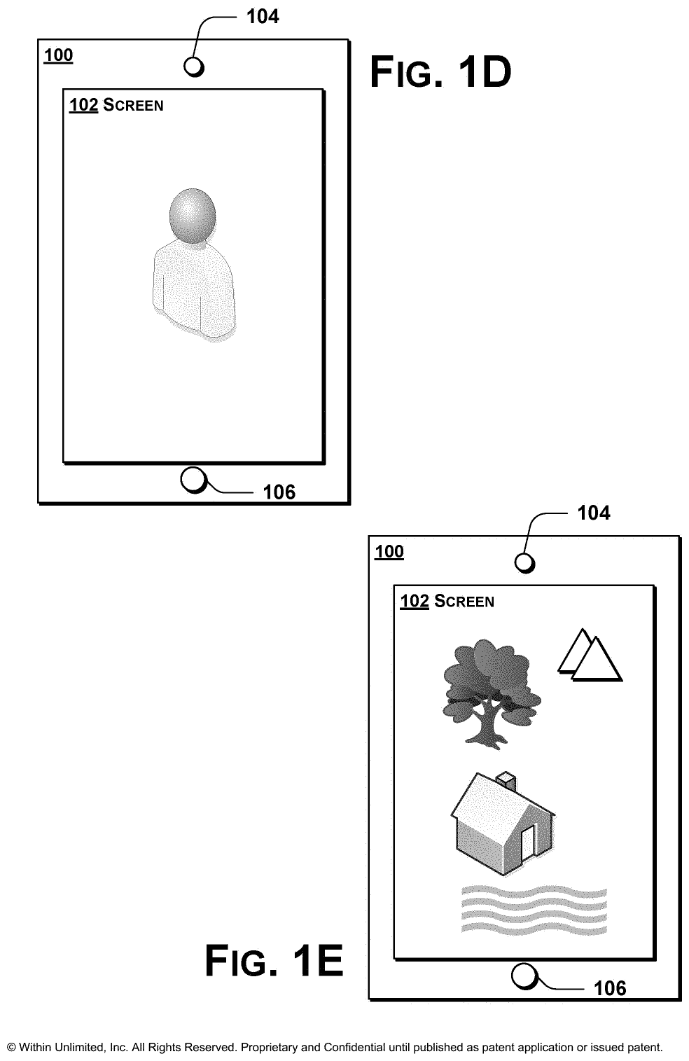

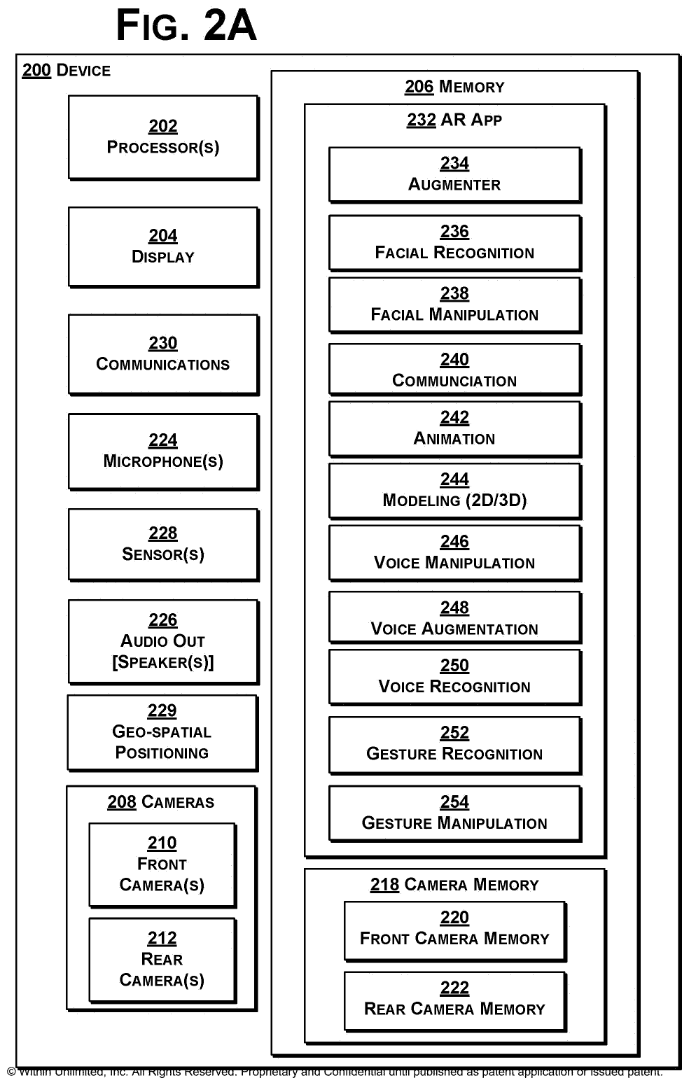

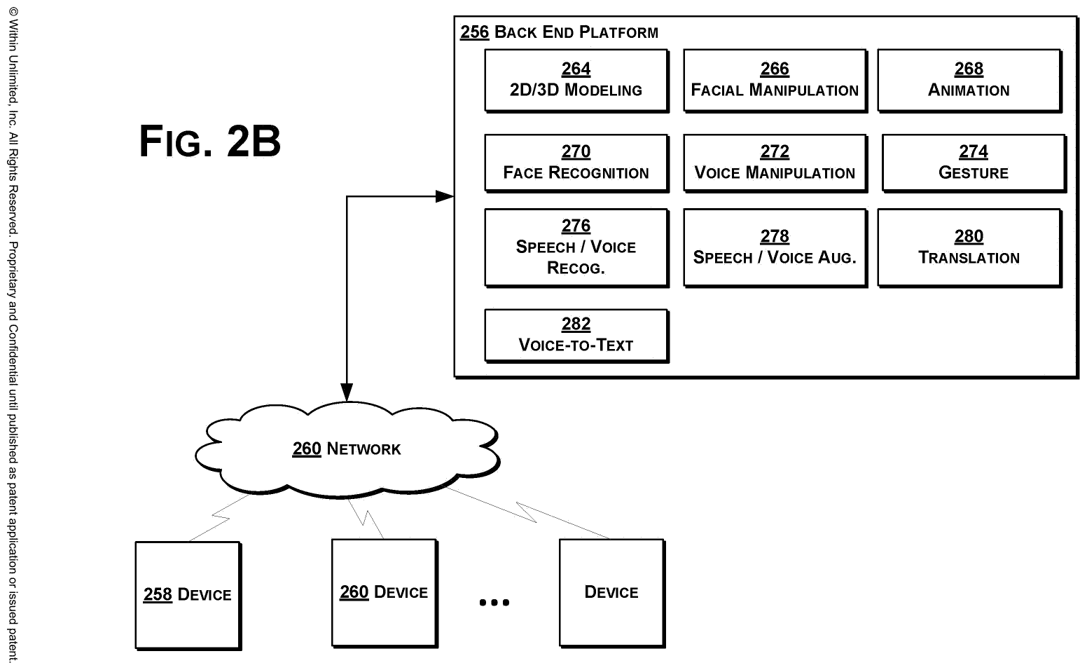

Such devices may be used to experience augmented reality (AR) environments such as those described herein. Accordingly, for the purpose of this specification, we first describe some standard functionalities of a typical device 100 such as a smartphone or tablet computer (e.g., an iPhone or Android phone, or an iPad, or the like). This will be described with reference to FIGS. 1A-1C.

FIG. 1A is a front view of an exemplary device 100, showing a display screen 102, a front camera 104, and a control button 106. FIG. 1B shows a rear view of the device 100, showing a rear camera 108. For the sake of this description, and without loss of generality, the front camera 104 is on the same side of the device as the display screen 102. Other buttons and components of the device (such as a microphone and speaker) are not shown.

As should be appreciated, the drawings in FIGS. 1A-1C are stylized exemplary views of the device, and the positions of the cameras are just given by way of example. However, for preferred embodiments it is presumed that a device has at least one camera with a rear view. More preferably, a device has at least one camera that has a front view and at least one other camera that has a rear view. Furthermore, although one front camera and one rear camera are shown, a device may have multiple front cameras and multiple rear cameras. Thus, unless specifically stated otherwise, the reference to a camera refers to one or more cameras (e.g., “a front camera” refers to “one or more front cameras,” sometimes written as “front camera(s),” etc.)

FIG. 1C is a side view of the device 100, showing (in dashed lines), the front and rear views of the front camera(s) 104 and the rear camera(s) 108, respectively. In this example, the front view (i.e., the view of the front camera(s) 104) faces the user 110, whereas the rear view (i.e., the view of the rear camera(s) 108) faces away from the user. In this example (and only by way of example), the rear view includes a house and a tree.

In conventional usage, when the front camera 104 is active, then the display screen 102 shows an image corresponding to the view of the front camera 104 (e.g., in the example of FIG. 1C, a view that includes the user 110, as shown in FIG. 1D). When the rear camera 108 is active, then the display screen 102 shows the view of the rear camera 108 (e.g., in the example of FIG. 1C, a view that includes the tree and house, as shown in FIG. 1E). Note that if the view from the rear camera 108 is augmented with virtual objects, as described below, the view may also include virtual objects augmented into the view (e.g., the triangles and waves in FIG. 1E).

As used herein, the term “virtual object” or (“object” in the context of a virtual space) refers to any object or part thereof, real or imaginary, and may include faces, bodies, such as an avatar or the like. A virtual object may be static or dynamic and may be animatable and otherwise manipulatable in the object's virtual space. A virtual object may be associated in the AR space with one or more other objects, including other virtual and real-world objects. For example, a virtual object may be a face associated with a real person or animal in an AR space.

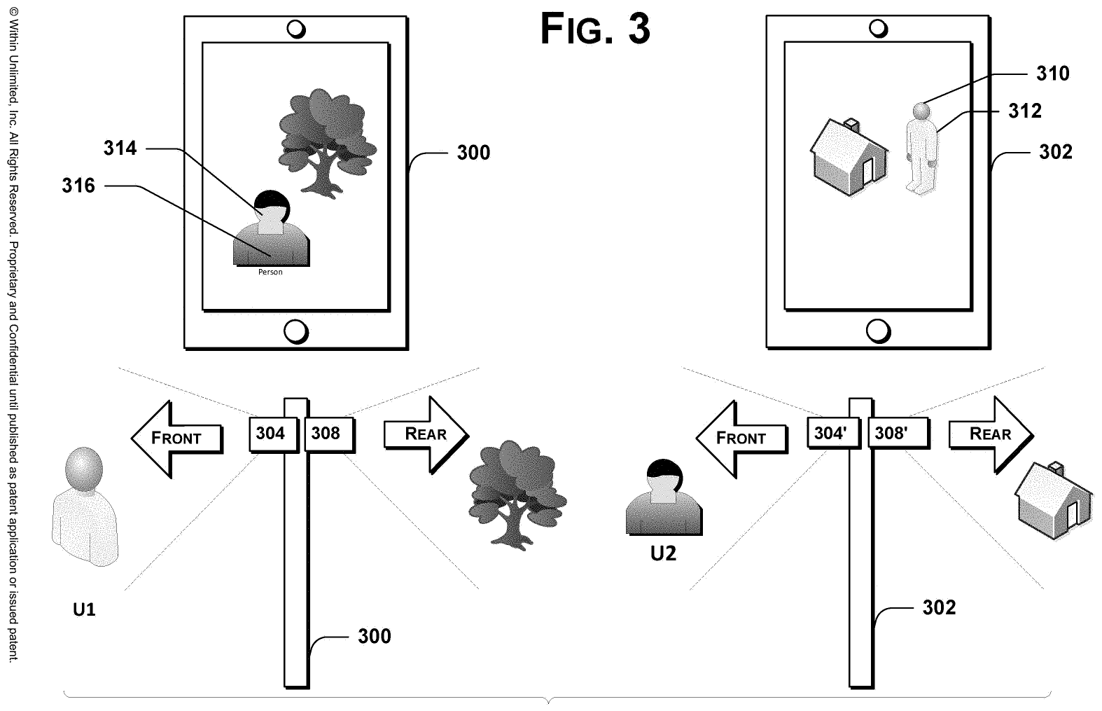

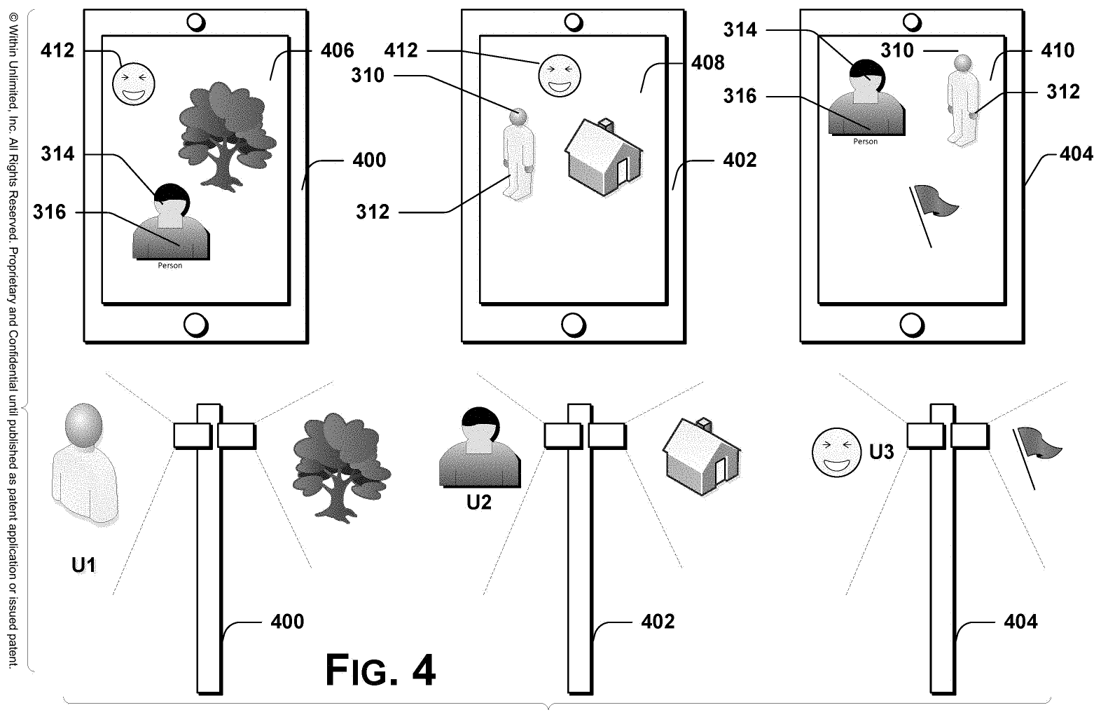

With reference now to FIG. 2A, additional aspects of the components of a device 200 (such as the device 100 shown in FIGS. 1A-1C) will be described according to exemplary embodiments hereof.

Device 200 may include one or more processors 202, display 204 (corresponding, e.g., to screen 102 of device 100), and memory 206. Various programs (including, e.g., the device's operating system as well as so-called applications or apps) may be stored in the memory 206 for execution by the processor(s) 202 on the device 200.

The memory may include random access memory (RAM), caches, read only storage (e.g., ROMs, etc.). As should be appreciated, the device 200 (even if in the form of a smartphone or the like) is essentially a computing device (described in greater detail below).

The device 200 may include at least one camera 208, preferably including one or more front cameras 210, and one or more rear cameras 212. The cameras may be capable of capturing real time view images (still or video) of objects in their respective fields of view. In some embodiments hereof, the front and rear cameras may operate at the same time (i.e., both the front and rear cameras can capture images at the same time). That is, in some embodiments, the front camera(s) 210 may capture video or still images from the front of the device while, at the same time, the rear camera(s) 212 may capture video or still images from the rear of the device. Whether and how any of the captured images get displayed, rendered or otherwise used is described below. The front cameras 210 may correspond to front camera(s) 104 in device 100, and the rear cameras 212 may correspond to the rear camera(s) 108 in device 100.

The memory 206 may include camera memory 218 provided or allocated for specific use by the cameras. The camera memory 218 may be special purpose high-speed memory 208 (e.g., high-speed frame buffer memory or the like) and may include front camera memory 220 for use by the front camera(s) 210, and rear camera memory 222 for use by the rear camera(s) 212.

The device 200 may also include one or more microphones 224 to pick up sound around the device and one or more speakers 226 to play audio sound on the device. The device may also support connection (e.g., wireless, such as Bluetooth, or wired, via jacks) of external microphones and speakers (e.g., integrated into a headset).

The device may include one or more sensors 228 (e.g., accelerometers, gyroscopes, etc.) and an autonomous geo-spatial positioning module 229 to determine conditions of the device such as movement, orientation, location, etc. The geo-spatial positioning module 229 may access one or more satellite systems that provide autonomous geo-spatial positioning, and may include, e.g., the GPS (Global Positioning System), GLONASS, Galileo, Beidou, and other regional systems.

The device preferably includes one or more communications mechanisms 230, supporting, e.g., cellular, WiFi, Bluetooth and other communications protocols. For example, if the device 200 is a cell phone, then the communications mechanisms 230 may include multiple protocol-specific chips or the like supporting various cellular protocols. In this manner, as is known, the device may communicate with other devices via one or more networks (e.g., via the Internet, a cellular network, a LAN, a WAN, a satellite connection, etc.).

In some exemplary embodiments, devices may communicate directly with each other, e.g., using an RF (radio frequency) protocol such as WiFi, Bluetooth, Zigbee, or the like.

The communications mechanisms 230 may also support connection of wireless devices such as speakers and microphones mentioned above.

### Overview of the Augmented Reality Mechanisms

The AR App

In some aspects, exemplary embodiments hereof provide a system that creates, supports, maintains, implements and generally operates various augmented reality (AR) elements, components, collaborations, interactions, experiences and environments. The system may use one or more devices such as the device 200 as a general AR processing and viewing device, and as such, the system may include an AR mechanism that may reside and operate on the device 200 as depicted in FIG. 2A. The AR mechanism(s) may include a wide variety of other mechanisms that may allow it to perform all of the functionalities as described herein. In addition, the AR mechanism(s) may use and/or be implemented using the native functionalities of the device 200 as necessary.

As depicted in FIG. 2A, the AR mechanism may be an AR App 232 that may be loaded and run on device 200. The AR App 232 may generally be loaded into the memory 206 of the device 200 and may run by the processor(s) 202 and other components of device 200.

The AR APP 232 may include one or more of the following mechanisms:

1. Augmenter mechanism(s) 234

2. Face recognition mechanism(s) 236

3. Facial manipulation mechanism(s) 238

4. Communication mechanism(s) 240

5. Animation mechanism(s) 242

6. 2-D and 3-D modeling mechanism(s) 244

7. Speech or voice manipulation mechanism(s) 246

8. Speech or voice augmentation mechanism(s) 248

9. Voice Recognition mechanism(s) 250

10. Gesture recognition mechanism(s) 252

11. Gesture manipulation mechanism(s) 254

This list of mechanisms is exemplary, and is not intended to limit the scope of the invention in any way. Those of ordinary skill in the art will appreciate and understand, upon reading this description, that the AR App 232 may include any other types of recognition mechanisms, augmenter mechanisms, manipulation mechanisms, and/or general or other capabilities that may be required for the AR App 232 to generally perform its functionalities as described in this specification. In addition, as should be appreciated, embodiments or implementations of the AR App 232 need not include all of the mechanisms listed, and that some or all of the mechanisms may be optional.

The mechanisms are enumerated above to provide a logical description herein. Those of ordinary skill in the art will appreciate and understand, upon reading this description, that different and/or other logical organizations of the mechanisms may be used and are contemplated herein. It should also be appreciated that, while shown as separate mechanisms, various of the mechanisms may be implemented together (e.g., in the same hardware and/or software).

As should be appreciated, the drawing in FIG. 2A shows a logical view of exemplary aspects of the device, omitting connections between the components.

In operation, the AR App 232 may use each mechanism individually or in combination with other mechanisms. When not in use, a particular mechanism may remain idle until such time its functionality may be required by the AR App 232. Then, when the AR App 232 may require its functionality, the AR App 232 may engage or invoke the mechanism accordingly.

Note also that it may not be necessary for the AR App 232 to include all of the mechanisms listed above. In addition, the AR App 232 may include mechanisms that may not be in the above list.

The different mechanisms may be used for different types of AR experiences or programs that the AR App 232 may provide. In addition, the end user may desire to run and experience a specific AR program(s), and accordingly, may only require the mechanisms of the AR App 232 that may drive that particular AR program(s). In this situation, the unused mechanisms (if included in the AR App 232) may sit idle, the AR App 232 may not include the unnecessary mechanism, or any combination thereof.

The AR App 232 may orchestrate the use of various mechanisms combined with native functionalities of the device 200 to perform, create, maintain and generally operate a wide variety of different types of AR experiences, interactions, collaborations and environments.

As noted above, a virtual object may be animatable and otherwise manipulatable in the object's virtual space. Such animation and/or manipulation may use various of the AR app's mechanisms, including, e.g., augmenter mechanism(s) 234, facial manipulation mechanism(s) 238, animation mechanism(s) 242, 2-D and 3-D modeling mechanism(s) 244, and gesture manipulation mechanism(s) 252.

Speech produced by an object in an AR space (virtual or real, including a real person) may be manipulated or augmented by various of the AR app's mechanisms, including, e.g., speech or voice manipulation mechanism(s) 246, and speech or voice augmentation mechanism(s) 248. As used herein, the term “speech,” in the context of an AR environment or space, refers to any sound that may be used to represent speech of an object or real-world person. Augmented or manipulated speech may not correspond to any actual speech or language, and may be incomprehensible.

The Backend Platform

As should be appreciated, although the functionality provided by the AR app 232 is preferably available on the device 200, aspects of the functionality may be provided or supplemented by mechanisms located elsewhere (e.g., a backend platform).

Accordingly, as shown, for example, in FIG. 2B, an AR system according to exemplary embodiments hereof may also include a backend platform 256 that may provide resources or mechanisms to support the AR app 232 on one or more devices. As depicted in the drawing in FIG. 2B, devices 258, 260, etc. (each corresponding, e.g., to device 200 in FIG. 2A) may be in communication with each other via one or more networks 260, and may, at the same time, each be in communication with the backend platform 256.

Data from the devices 258, 260, etc. may be communicated to each other as well as to the backend platform 256. The backend platform 256 may include one or more servers that may include CPUs, memory, software, operating systems, firmware, network cards and any other elements and/or components that may be required to the backend platform 256 to perform its functionalities.

Embodiments or implementations of backend platform 256 may include some or all of the functionalities, software, algorithms and mechanisms necessary to correlate, process and otherwise use all of the data from the devices 258, 260, etc.

A backend platform 256 according to exemplary embodiments hereof may include services or mechanisms to support one or more of the following: 2-D and 3-D modeling mechanism(s) 264, facial manipulation/animation mechanism(s) 266, animation mechanism(s) 268, face recognition mechanism(s) 270, voice manipulation mechanism(s) 272, gesture recognition mechanism(s) 274, speech and/or voice recognition mechanisms 276, speech and/or voice augmentation mechanism(s) 278, language translation mechanism(s) 280, voice-to-text mapping mechanism(s) 282, etc. In general, there may be one or more mechanisms on the backend platform 256 corresponding to each of the device mechanisms (in the AR app 232).

A particular implementation of a backend platform may not have all of these mechanisms and may include other mechanisms not listed here. The mechanisms on the backend platform may augment or replace mechanisms on the devices, e.g., on an as-needed basis.

Thus, a device, while in conversation with another device, may also be connected to a backend platform for support with one or more of its AR mechanisms.

Although various mechanisms are shown on the backend platform 256 in FIG. 2B, it should be appreciated that a particular implementation of the backend platform may obtain information and/or processing from other platforms or systems (not shown). For example, a particular backend platform may obtain language translation services from another platform or system (not shown).

As an example, a backend platform may support the 2-D and 3-D modeling mechanism(s) 244 on a device (e.g., one of devices 258, 260, etc.). As should be appreciated, building and sharing comprehensive 3-D models of augmented physical environments may require significant processing power as well as a large amount of memory—sometimes more than is available on a single device.

Data from one or more devices may be communicated to/from the backend platform 256 on a continual basis, and 2-D and 3-D modeling mechanism(s) 264 on the backend platform 256 may accordingly create 2-D or 3-D models and communicate them back to the devices. Some of the processing of the data and model creation may occur on the devices and some of the processing and model creation may occur on the backend platform 256, or any combination thereof

Real Time

Those of ordinary skill in the art will realize and understand, upon reading this description, that, as used herein, the term “real time” means near real time or sufficiently real time. It should be appreciated that there are inherent delays in electronic components and in network-based communication (e.g., based on network traffic and distances), and these delays may cause delays in data reaching various components. Inherent delays in the system do not change the real time nature of the data. In some cases, the term “real time data” may refer to data obtained in sufficient time to make the data useful for its intended purpose.

Although the term “real time” may be used here, it should be appreciated that the system is not limited by this term or by how much time is actually taken. In some cases, real-time processing or computation may refer to an online process or computation, i.e., a process or computation that produces its answer(s) as data arrive, and generally keeps up with continuously arriving data. The term “online” computation is compared to an “offline” or “batch” computation.

### EXAMPLES

Operation of aspects of the AR system, including AR App 232, alone or in conjunction with a backend platform 256, will be described by way of several detailed examples.

The examples provided below are chosen to illustrate different types or combinations of AR experiences and programs that exemplary implementations of the AR App 232 may execute. Each example may purposely demonstrate the utilization of different mechanisms (or combinations of different mechanisms) within the AR App 232. Those of ordinary skill in the art will appreciate and understand, upon reading this description, that the examples are not limiting and that the AR App 232 may be used in different way.

For example, one descriptive example presented below may include an AR program that may include two or more users each with a device 200 that may be running the AR App 232. The users may be in communication with each other via the devices 200 and may each view their respective AR environments augmented with images of the other user. Note that this example may demonstrate the utilization of the communication mechanism 240, the augmenter mechanism 234, the facial recognition mechanism 236, the facial manipulation mechanism 238, the voice manipulation mechanism 246 and the animation mechanism 242. The functionalities of the above mechanisms may be used independently or in any combination with one another as necessary for the AR App 232 to perform the functionalities as described.

Another descriptive example presented below may include a storytelling program that may augment the viewed environment of the user with virtual objects or elements as a part of a moving storyline. Note that this example may demonstrate the utilization of the communication mechanism 240, the augmenter mechanism 234, the gesture recognition mechanism 252 and the voice recognition mechanism 250. The functionalities of the above mechanisms may be used independently or in any combination with one another as necessary for the AR App 232 to perform the functionalities as described.

Note that some of the examples presented may use similar but not identical combinations of the mechanisms (i.e., the examples may share the use of some of the mechanisms but not others). Note also that the AR App 232 may include some mechanisms that may not be necessarily used in some of the examples, and that these mechanisms (if implemented in a particular embodiment or implementation) may rest idle when not in use. Alternatively, the unused mechanisms may not be included in AR App 232 (e.g., per a user's decision during the configuration of the AR App 232).

It should be appreciated that the examples presented do not limit the scope of the current invention to the specific functionalities that they may demonstrate, and that other mechanisms and/or combinations of mechanisms included with and engaged by the AR App 232 may result in other functionalities or combinations of functionalities that may not specifically be demonstrated in the examples but that are within the scope of the invention.

### Example: Real-Time Communication and Collaboration

Exemplary embodiments hereof (e.g., the AR app 232, alone or in conjunction with a backend platform 256) may be used for real-time communication and collaboration with AR.

For example, as depicted in FIG. 3, a first user U1 has a first device 300 (corresponding to device 200 in FIG. 2A) running a version of the AR program 232 on the first device, and a second user U2 has a second device 302 (also corresponding to device 200 in FIG. 2A), also running a version of the AR program 232 on the second device. Using the AR program 232, users U1 and U2 are in communication with each other (e.g., via a cellular network, a LAN, a WAN, a satellite connection, etc.).

Although the term “collaborative” may be used throughout this specification to describe the operation of the device 200 and the AR program 232, it should be appreciated that the invention is not limited by the term “collaborative,” and the term encompasses any kind of conversation or interaction between two or more users, including, without limitation, real-time voice and video conversations and/or interactions and/or chatting.

Using the AR program 232, a device's front and rear cameras are simultaneously active, and the first user's device 300 renders on its display (i) a view from its rear camera 308, augmented with (ii) one or more images based on the view from user U2's front camera 304′. At the same time, the second user's device renders on its display (i) a view from its rear camera 308′, augmented with (ii) one or more images based on the view from user U1's front camera 304.

As noted, using the camera(s) 208, the device 200 can receive live video of a real-world, physical environment. As used herein, the term “live” means at the time or in substantially real time. Thus, “live video” corresponds to video of events, people, places, etc. occurring at the time the video is transmitted and received (taking into account processing and transmission delays). Similarly, “live audio” refers to audio captured and transmitted at the time of its capture.

Thus, each user's display shows a real time view from their rear camera, augmented with an image based on a real time view of the other user's front camera. As explained, the images that a device renders from another user's device are based on the images from that other device, but need not necessarily be the same as the images from the other device. For example, the images may be stylized, augmented, animated, resized, etc.

In a simple case, the images from the front camera(s) of the first user's device are superimposed in some manner (on the display of the second user's device) on the images from the rear camera(s) of the second user's device, and vice versa.

Communication and collaboration via the AR app is not limited to two users.

An example AR collaboration or interaction with three users is shown in the stylized drawing in FIG. 4. As shown in FIG. 4, each user's display shows a real time view from their own rear camera, augmented with images based on real time views of the other users' front cameras. Thus, in this example, images based on the front cameras of users U1 and U2 appear in the display 410 of user U3, augmenting the real-time view from user U3's rear camera, etc.

In general, a user's screen may display images from any of the other user's camera(s), alone, or along with AR images.

With reference again to FIG. 2A, in order to communicate with other devices, the AR app 232 preferably includes a communication module or mechanism 240 that uses the device's communications mechanism(s) 230 to establish connections with other users. The connections may be via a backend (e.g., backend platform 256 in FIG. 2B) or the like, and may require authentication and the like. The AR app 232 preferably makes use of other inter-device communication mechanisms for setup of inter-device (inter-user) communications.

An augmenter mechanism 234 combines real-time video images from the device's rear camera(s) 212 (e.g., from rear camera memory 222) with some form of the image(s) received in real-time from one or more other devices. The images from the other devices may be augmented.

In some preferred embodiments, the AR app 232 has (or has access to) one or more mechanisms, including: face recognition mechanism(s) 236, facial manipulation mechanism(s) 238, and voice manipulation mechanism(s) 246. Each device 200 may use one or more of these mechanisms to manipulate the images and/or audio from its front camera(s) 210 prior to sending the images and/or audio to other users. For example, using the AR app 232, a device 200 may use the face recognition mechanism(s) 236 to find and store into memory 206 the user's face in the images received in real time by its front camera 210. The AR app 232 may the use facial manipulation mechanism(s) 238 to manipulate images (e.g., stored images) of the user's face prior to sending them to other users in a conversation or collaboration. The facial manipulation may, e.g., correspond to the user's facial expressions and/or gestures. The other users will then receive manipulated facial images or a stylized version of the sending user's face. The user may thus, e.g., send a stylized or graphically animated version of their face that moves in real time in correspondence to their actual face in front of the camera. The receiving user then receives the stylized or graphically animated version of the other user's face and uses their augmenter mechanism 234 to create an AR image combining the view from their rear camera and the received image.

In some embodiments, users may manipulate their voices using voice manipulation mechanism(s) 246, so that the audio that is sent to other users is a modified version of their actual voice. The voice manipulation occurs in real time and may use various kinds of filters and effects. Thus, the receiving user may receive a modified audio from a sending user. The voice manipulation may simply modulate aspects of the captured audio or it may completely change the audio (e.g., provide a translation to another language).

As should be appreciated, the audio and video manipulations may occur at the same time.

The augmenter mechanism 234 may superimpose some form of the image(s) received in real-time from one or more other users, or it may manipulate or augment them. Preferably, the augmenter mechanism 234 manipulates the images and/or audio received from other users before combining the received images and/or audio with the video from its own rear camera. Thus, in some preferred embodiments, preferably the combined and rendered image includes a manipulation of the images received from the other user's devices.

The AR app 232 may include one or more animation mechanisms 242, and, in some embodiments, the augmenter mechanism 234 may use the animation mechanism(s) 242 to animate images received from other users. For example, when the received image is a user's face (possibly modified and/or manipulated by the sender), the receiving device may put that face on a frame that may be animated (e.g., an avatar or the like) and then animate the combined face and frame using the facial manipulation mechanism(s) 238 and animation mechanism(s) 242. In these cases, the receiver's display will show the image from their rear camera, augmented with an animated version of the received image(s). The animated images may be in 2-D and/or 3-D.

Thus, e.g., with reference again to FIG. 3, the front camera(s) 304 of device 300 may capture a real-time image of user U1, find the user's face in that image with the device's face recognition mechanism(s) 236, and transmit to other users in the collaboration, a real-time manipulated face (manipulated with the device's facial manipulation mechanism(s) 238). The device 300 may also manipulate the user's (U1's) voice in real time (using the device's voice manipulation mechanism 246) and transmit to the other users in the collaboration an audio signal corresponding to U1's manipulated voice. On the receiving end (in this case only one other user is shown, although it should be understood that multiple other users may be involved in a collaboration), the receiving device 302 (of user U2) obtains a video signal and an audio signal from user U1's device. The video signal corresponds to U1's face, animated in real time (e.g., to correspond to U1's facial expressions and/or gestures). The receiving device may then use its augmenter mechanism 234 to augment the real time image it is capturing with its rear camera(s) (308′) with the received image. In this case, e.g., the augmenter mechanism 234 on device 302 may add user U1's face to a torso and may animate the combined torso and U1's face (using animation mechanism(s) 242 on device 302). At the same time, the audio output 226 on device 302 renders the audio received from U1's device 300.

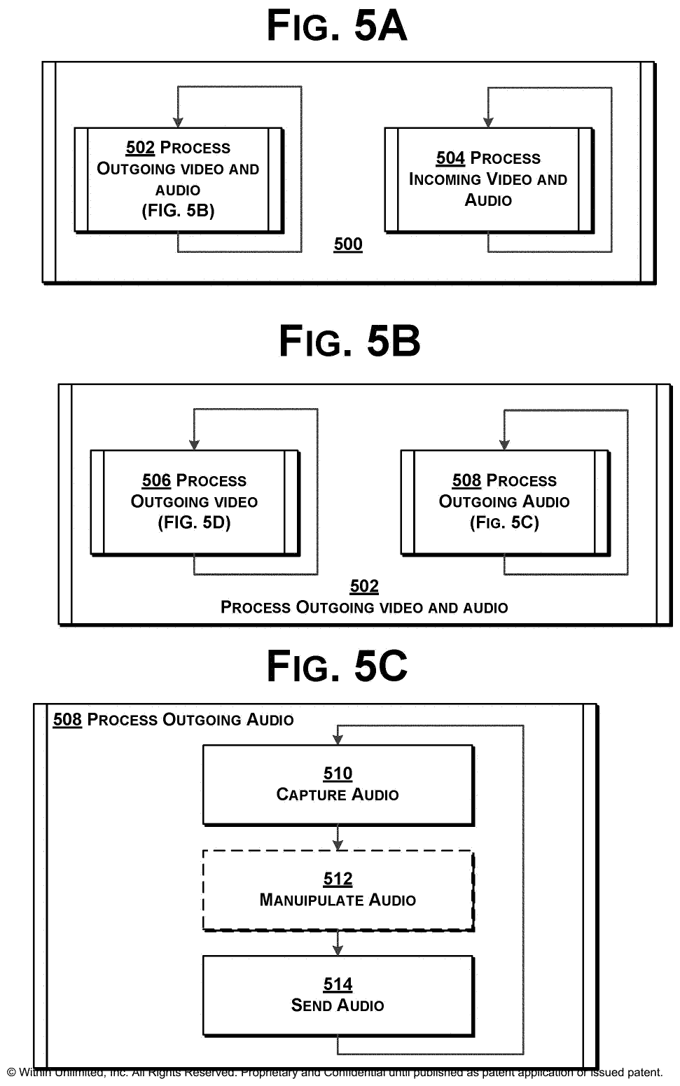

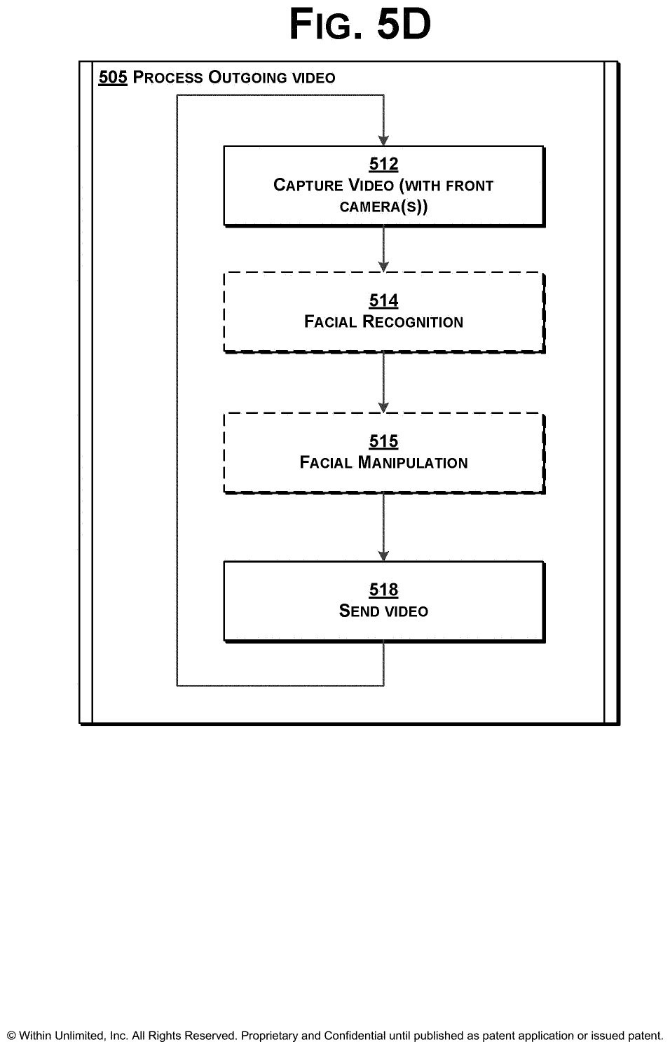

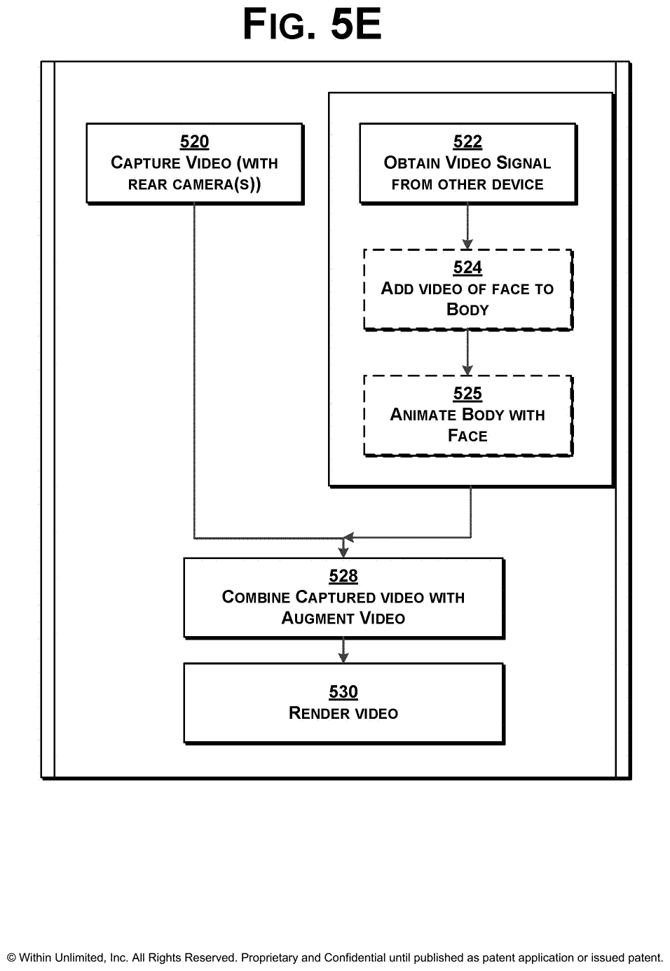

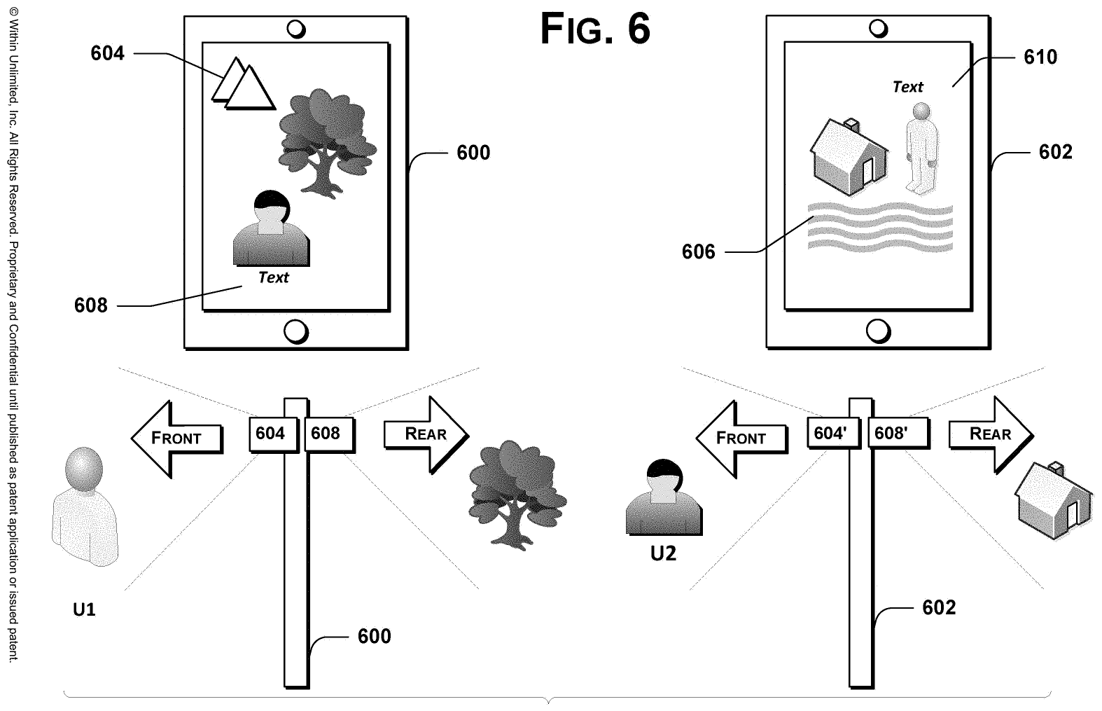

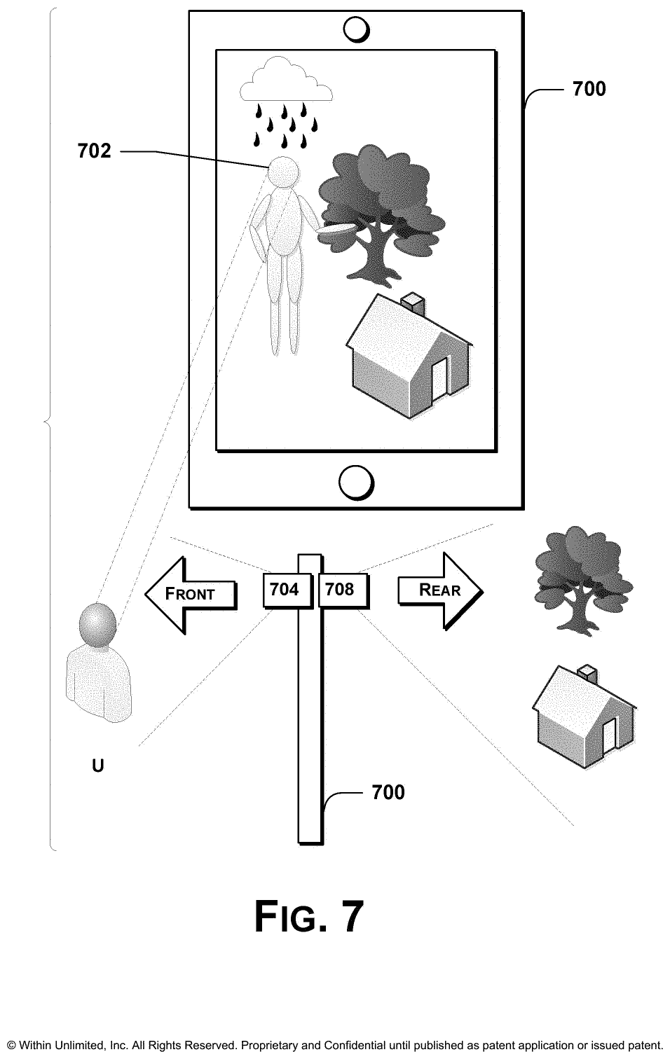

FIGS. 5A-5E show aspects of an exemplary flow of the AR App 232 on a user's device. Aspects such as setup and other administrative features are not shown. As shown in FIG. 5A, when the AR App 232 is running (at 500), it continuously processes outgoing audio and video to other users (at 502) while, at the same time, it continuously processes incoming video and audio from other users (at 504). Thus, as can be seen, outgoing processing and incoming processing may be considered independent of each other.

For the sake of this description, it can be assumed that all users in an AR collaboration are using a device running the AR app 232 with at least some of the functionality of the app. As should be appreciated, there is no requirement that the devices be the same or that all versions of the app support all of the features or that all supported features are enabled or being used. For example, a user may choose not to use the voice manipulation mechanism 246. As another example, a device may not support the simultaneous use of front and back cameras, in which case, that device may not have an AR view that other devices in the collaboration can create.

FIG. 5B shows aspects of the exemplary flow of the AR app 232 on a user's device, processing outgoing video (at 506) and audio (at 508). As shown in FIG. 5B, when the AR App 232 is running (at 500), it continuously processes outgoing video to other users (at 506) while, at the same time, it continuously processes outgoing audio to other users (at 508). Thus, as can be seen, outgoing video and audio processing may be considered independent of each other.

FIG. 5C shows aspects of the exemplary flow of the AR app 232 on a user's device, processing outgoing audio (at 508). In a preferred embodiment, the outgoing audio signal is based on the real time capture of the user's voice on the device. The audio signal (e.g., the user's voice) is captured (at 510, e.g., using the microphone(s) 224) and then optionally manipulated (at 512), using voice manipulation mechanism(s) 246, and then sent (at 514) to the other devices in the conversation. The manner in which the user selects whether/how to manipulate their voice is not shown. As noted above, the voice manipulation may take place in part or entirely on the sending device or on the receiving device. Additionally, either device may use aspects of the backend platform's voice manipulation 272.

FIG. 5D shows aspects of some of the exemplary flow of the AR app 232 on a user's device, processing outgoing video (at 506). In some preferred embodiments, the outgoing video is based on the real-time capture of video images from front camera(s) 210 of the device 200. First, video is captured (at 512) with the front camera(s) 210. Then, optionally, facial recognition is performed (at 514, using face recognition mechanism(s) 236) to find the user's face in the captured video. Then, optionally, facial manipulation is performed (at 516, using face manipulation mechanism(s) 238). Then the video (possible manipulated at 516) is sent (at 518) to other users in the conversation. The face recognition and facial manipulation may take place in part or entirely on the sending device or on the receiving device, or on any combination thereof. Additionally, either device may use mechanisms the backend platform 256, e.g., the backend platform's facial recognition mechanism(s) 270 and/or facial manipulation mechanism(s) 266.

FIG. 5E depicts aspects of the AR rendering on a receiving device (corresponding to processing incoming video and audio at 504 in FIG. 5A). On the receiving end, incoming audio is rendered using the devices audio output (e.g., speakers) 226.

As shown in FIG. 5E, the AR rendering consists of, in real time, capturing the real-time video from the devices rear camera(s) 212 (at 520) while, at the same time, obtaining (at 522) one or more incoming video signals (produced as described above with reference to FIGS. 5A, 5D), and (with the augmenter 234) augmenting the video from the rear camera(s) based on the incoming video signals. The augmenter mechanism(s) 234 may, optionally, add a received video to a body (at 524), and then (at 526) animate the combined body and face (using, the animation mechanism(s) 242). The augmented part (based on the incoming video signal) is combined with the captured video (at 528) and then rendered (at 530).

Aspects of the augmenting, including the animation, may take place in part or entirely on the device. Additionally, the device may use aspects of the back-end platform's facial manipulation/animation mechanism(s) 266.

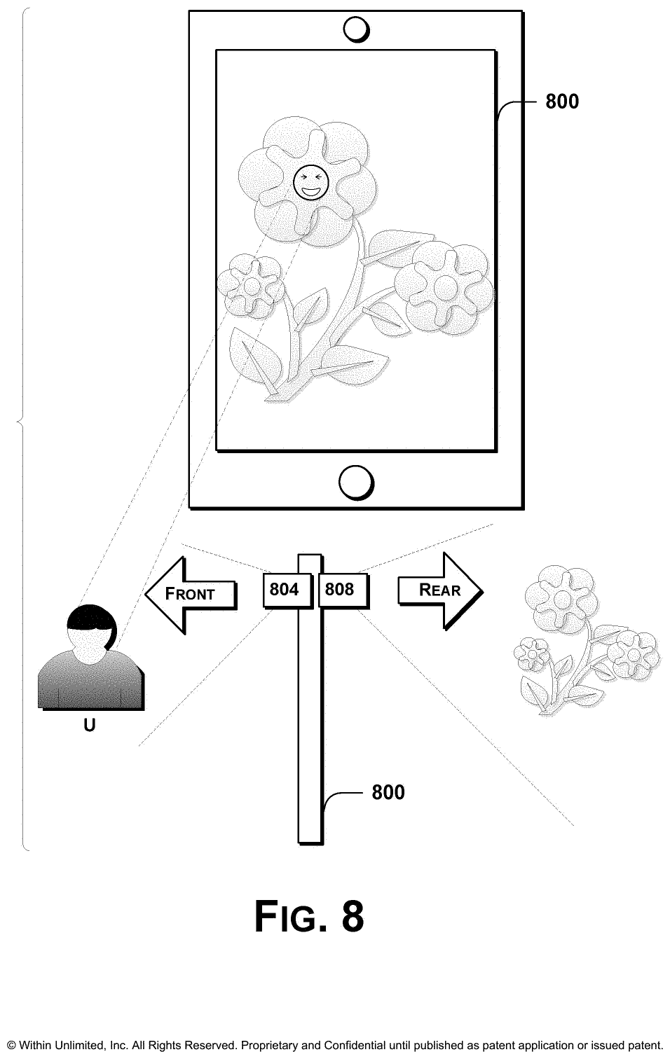

In some exemplary embodiments, a device's augmenter mechanism(s) 234 may add additional information or content to the image rendered. For example, as shown in FIG. 6, the device 600 (which is an embodiment of device 200 of FIG. 2A), renders one or more additional objects 604 in the image on its display. The additional objects 604 may be 2-D and/or 3-D objects. These objects may be entirely artificial or virtual or they may be stylized versions of real-world objects. The objects may be static or dynamic and may be animated. The device 600 may also render text 608 on its display. Although only one text object is shown, multiple text objects may be displayed. The text 608 may be a label (e.g., the user's name), a caption or subtitle (e.g., created by a voice-to-text mechanism on the device and/or on the backend.

Similarly, device 602 (also an embodiment of device 200), may render object(s) 606 and/or text 610. Note that the objects and/or text rendered on the various devices need not be the same.

In summary, in some aspects, with reference again to the drawing in FIG. 3, the front camera 304 of device 300 captures an image of user U1, and that image (or a version or rendering thereof), possibly augmented and/or animated, may be rendered as an object (e.g., a face 310) on an object (e.g., a body 312) on the display of the other user (U2). Similarly, the front camera 304′ of device 302 captures an image of user U2, and that image (or an image (or a version or rendering thereof), possibly augmented and/or animated, may be rendered as an object (e.g., a face 314) on an object (e.g., a body 316) on the display of the other user (U1).

Similarly, with reference again to the drawing in FIG. 4, the front camera of device 400 captures an image of user U1, and that image (or a version or rendering thereof), possibly augmented and/or animated, may be rendered as an object (e.g., a face 310) on an object (e.g., a body 312) on the displays of the other users (U2 and U3). Similarly, the front camera of device 402 captures an image of user U2, and that image (or a version or rendering thereof), possibly augmented and/or animated, may be rendered as an object (e.g., a face 314) on an object (e.g., a body 316) on the display of the other users (U1 and U3). And the front camera of device 404 captures an image of user U3, and that image (or a version or rendering thereof), possibly augmented and/or animated, may be rendered as an object (e.g., a face 412) on the displays of the other users (U1 and U2). Note that the image corresponding the user U3's face is not associated with another object (i.e., it is just a face, not on a torso).

### Example: Real-Time Augmentation Using the AR App

In another example of the AR program 232 to further illustrate aspects of its functionality, consider the example shown in FIG. 7, where a user U has device 700 (corresponding to device 200 in FIG. 2A) running an embodiment of the AR program 232.

Using the AR program 232, a device's front and rear cameras are simultaneously active, and the user's device 700 renders on its display (i) a view from its rear camera(s) 708, augmented with (ii) one or more AR images based on image(s) captured by the device's front camera(s) 704. In a preferred embodiment, the user's face (based on real time images captured by the front camera(s) 704, and using face recognition mechanism(s) 236) is mapped to a part of the images rendered on the display of device 700. In the example shown in FIG. 7, the user's face (or an image based thereon) is rendered in real time on an AR figure or body 702. The figure or body 702 may comprise an animatable frame.

The image rendered on the device's display may include other AR images or objects that are not based on either the front or rear camera views. For example, as shown in FIG. 7, the displayed image may include the AR figure or body 702 and, e.g., an AR rain cloud even though neither the body or cloud are in the front or rear cameras' views. The other AR images or objects may be animated or static.

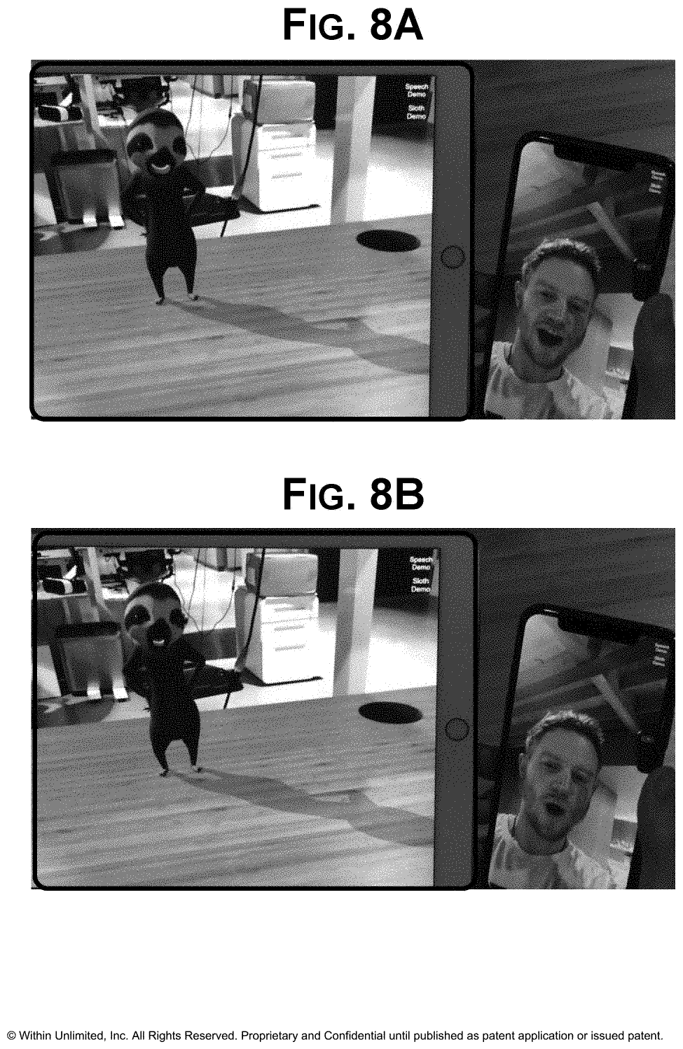

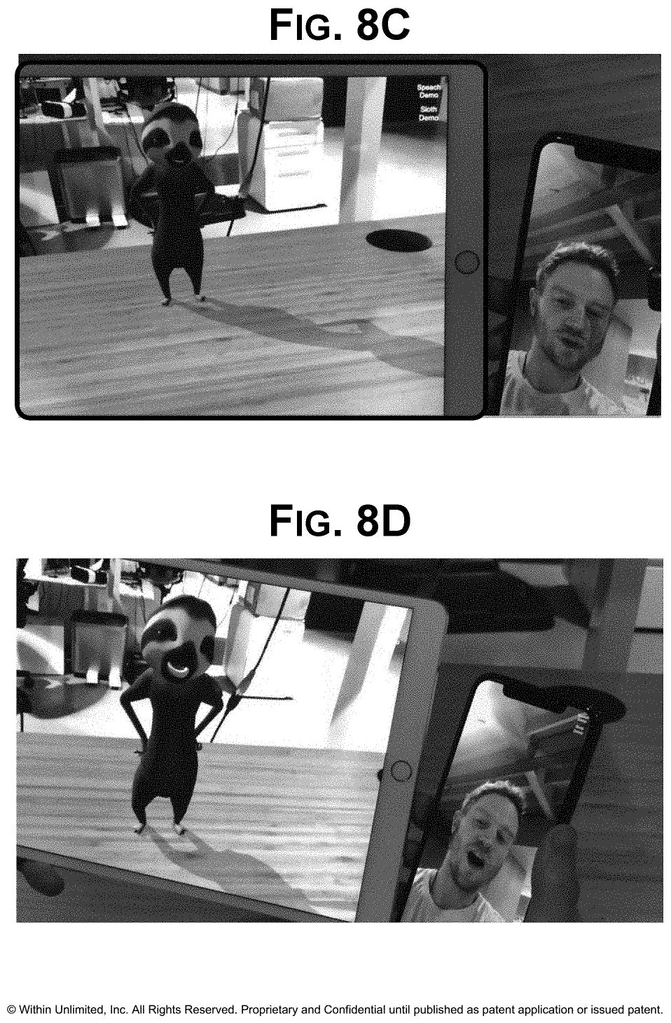

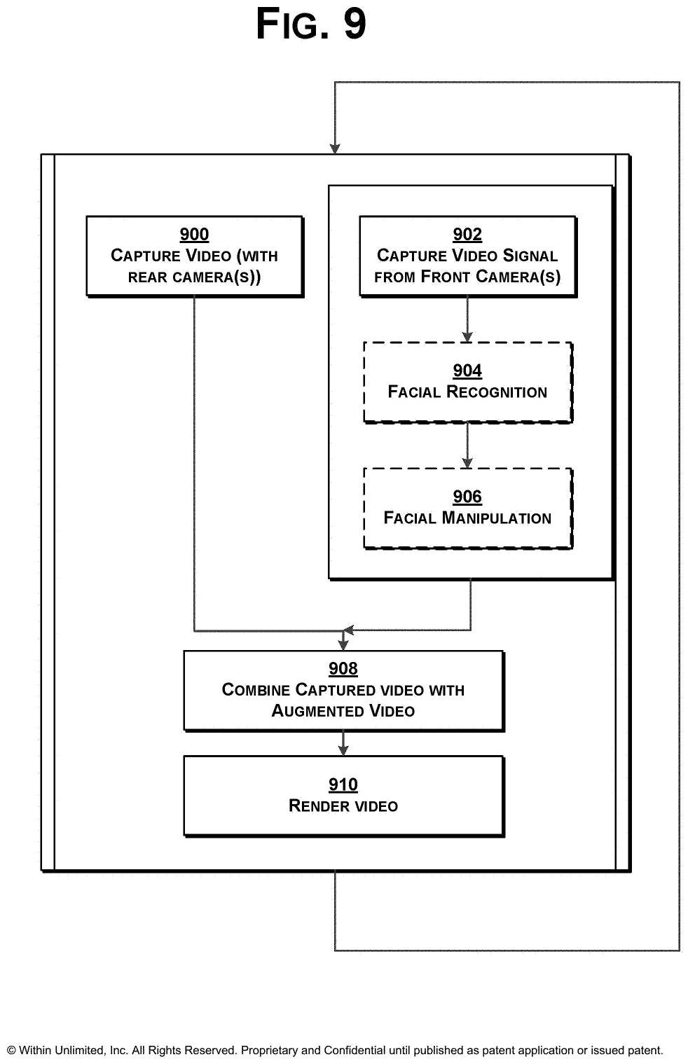

In another example, as shown in the stylized drawing in FIG. 8, a real-world object (e.g., a flower), as captured live in real time by the rear camera 808 of the device 800, is augmented with an AR image based on the user's face (as captured live in real time by the front camera 804 of device 800). Again, in the simplest case, the user's face may be simply superimposed in some manner on the image captured by the rear camera.

Since the images captured by the front and rear cameras are live and in real time, changes to either camera's view will cause corresponding changes to the rendered AR view. For example, if the user smiles then the AR facial image of the user may also smile. If the user changes the real-world view of either camera, then the corresponding rendered images will change. For example, if the user faces the rear camera to another location then the rendered AR image will include that other location.

With reference again to FIG. 2A, the AR app 232 may use communications mechanism(s) 240 to establish connections with other users. The connections may be via a backend platform (FIG. 2B) or the like and may require authentication and the like. The AR app 232 may make use of other inter-device communication mechanisms for setup of inter-device (inter-user) communications.

The augmenter mechanism(s) 234 may combine real-time video images from the devices rear camera(s) 708 (e.g., from rear camera memory 222) with some form of the image(s) received in real-time from the device's front camera(s). In some embodiments, the device may also include images (real and/or augmented) from one or more other users.

In some preferred embodiments, the AR app 232 may use its face recognition mechanism(s) 236 and facial manipulation mechanism(s) 238, to manipulate the images from its front camera(s) 704. For example, using the AR app 232, a device 700 may use the face recognition mechanism(s) 236 to find the user's face in the images received in real time by its front camera 704. The app 232 may the use the facial manipulation mechanism(s) 238 to manipulate the images of the user's face prior to rendering them as AR images. The facial manipulation may, e.g., correspond to the user's facial expressions and/or gestures. The user may thus, e.g., render a stylized or graphically animated version of their face that moves in real time in correspondence to their actual face in front of the camera in order to create an AR image combining the view from their front and rear cameras.

The augmenter mechanism 234 may simply superimpose some form of the image(s) received in real-time from the front camera(s), or it may manipulate or augment them. Preferably the augmenter mechanism 234 manipulates the images received from the front camera(s) before combining them with the video from its rear camera.

In some embodiments, the augmenter mechanism 234 may use the animation mechanism(s) 242 to animate AR images. For example, when the image from a front camera is a user's face (possibly modified and/or manipulated), the device may put that face on an animatable frame (e.g., an avatar or the like) and then animate the combined face and frame using the animation mechanism(s) 242. In these cases, the display will show the image from their rear camera, augmented with an animated version of the image(s) from the front camera. The animated images may be in 2-D and/or 3-D.

Thus, e.g., with reference again to FIG. 7, the front camera 704 of device 700 may capture a real-time image of user U, find the face in that image with the device's face recognition mechanism 236, and combine a real-time manipulated face (manipulated with the device's facial manipulation mechanism 238) with the image(s) captured by the device's rear camera(s).

FIGS. 8A-8D show an example of image animation and manipulation according to exemplary embodiments hereof. As shown in the images in FIGS. 8A-8D, the face of the virtual sloth (on the device on the left side) is animated by the facial movements on the person on the right. In addition, the speech of the person on the right is played on the device (as if spoken by the sloth). The system thus, in real time, tracks one user's face and speech and animates and augments a virtual object (a virtual sloth) on another device.

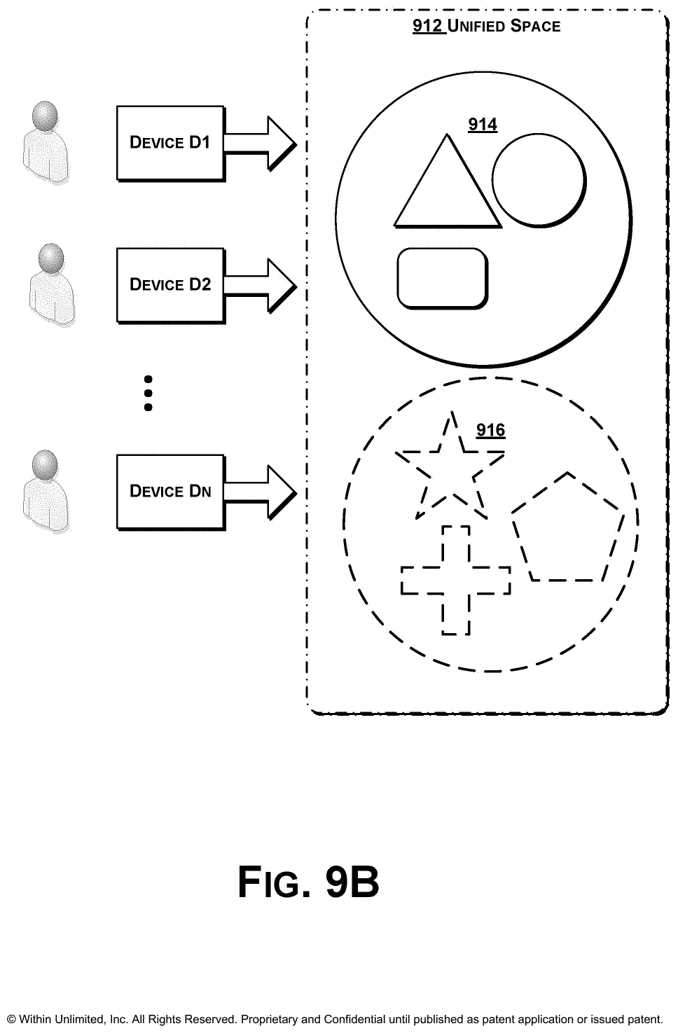

FIG. 9 shows aspects of exemplary flow of the AR App 232 on a user's device. Aspects such as setup and other administrative features are not shown. As shown in FIG. 9, when the AR App 232 is running, it continuously captures real-time live video with the rear camera(s) (at 900) while, at the same time, it continuously captures and processes video from the front camera(s) (at 902, 904, 906).

The augmenter mechanism(s) 234 may, optionally, add a received video to a body, and then animate the combined body and face (using, the animation mechanism(s) 242). The augmented part (based on the video signal from the front camera(s)) is combined (at 908) with the captured video from the rear camera(s) and then rendered (at 910).

In some exemplary embodiments, the augmenter mechanism 234 may add additional information or content to the image rendered. For example, the device (an embodiment of device 200 of FIG. 2A), may render one or more additional objects in the image on its display (e.g., the rain cloud in FIG. 7). The additional objects may be 2-D and/or 3-D objects. These objects may be entirely artificial or virtual or they may be stylized versions of real-world objects. The objects may be static or dynamic and may be animated. The device may also render text on its display. The text may be any text, including, e.g., a label, a caption or subtitle (e.g., created by a voice-to-text mechanism on the device and/or on the backend platform).

Unified Viewing Space

In general, each device has a view of the same unified space. Thus, as shown in logical diagram FIG. 9B, the n devices D₁, D₂ . . . Dₙ, each have a view of the unified viewing space 912 made up of live real-world objects 914, and virtual (or AR) objects 916 (depicted with dashed lines in the drawing). The devices may not all see the same parts of the unified space at the same time. For example, a device's view of the unified viewing space may depend on the device's location, position, orientation, etc.

The virtual or AR objects 916 in the viewing space 912 may depend on the application and/or use case. For example, in the example in FIG. 7 above, the AR objects 916 include the figure or body 702, and the real-world objects 914 include the tree and the house (captured by the rear camera 708).

The virtual/AR objects 916 may be generated by the application on one or more of the devices or by another application or the backend.

Those of ordinary skill in the art will appreciate and understand, upon reading this description, that the various devices D₁ . . . Dₙ need not be in the same physical (or geographic) location.

### Example: Stories and Storytelling

In another exemplary embodiment, the AR program 232 may function for or in support of storytelling. For this embodiment, the AR program is also referred to as the AR Story program 232.

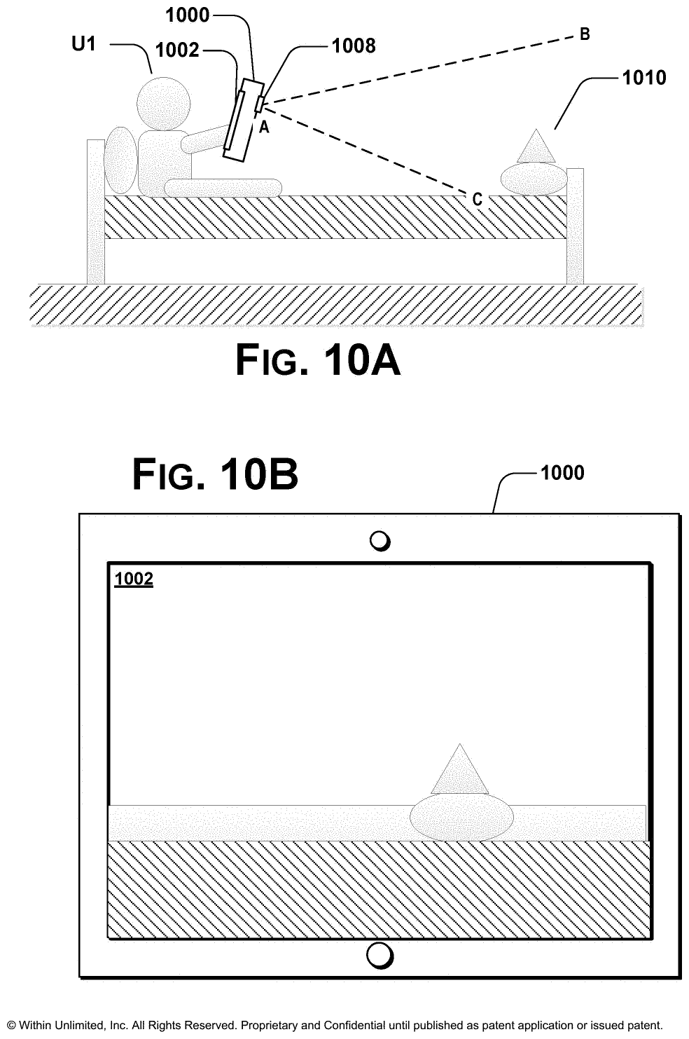

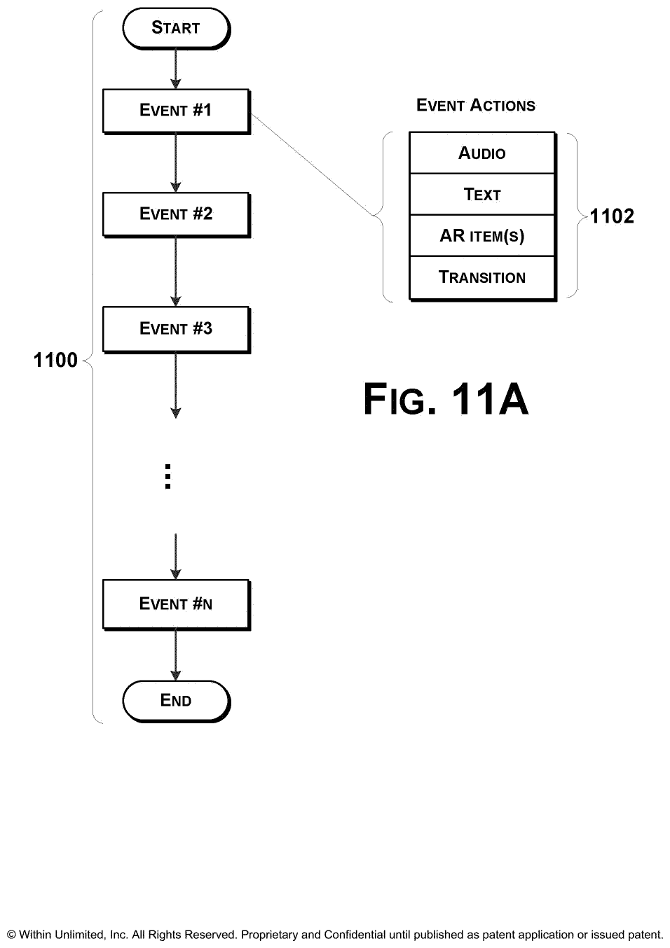

As an example of the story telling functionality, with reference to the drawing in FIG. 10A, a user U1 has device 1000 (corresponding to device 200 in FIG. 2A) running a version of the AR story program 232. The device is positioned such that the user U1 can view the device's display 1002 and the device's rear camera 1008 is capturing a view (shown in the drawing by the dashed lines AB and AC). In the example in the drawing the user U1 is sitting on a bed holding the device 1000, and the device's rear camera 1008 is capturing, in real time, a view of the end of the bed on which the user is sitting. In this example, some real-world objects (generally denoted 1010) are located on the end of the bed, within the camera's view. The view on the device's screen 1002 is shown in FIG. 10B. As will be appreciated, if the device's camera is moved, then the displayed scene will change, preferably in real time.

If the device also has a front camera (facing the user), then that front camera may capture images of the user at the same time that the rear camera is capturing the images of the bed. As explained below, images of the user from the front camera may be used for AR and/or control of the AR Story program 232.

When the AR story program 232 is used, the user may select a story, after which information about the story is loaded into the device's story memory.

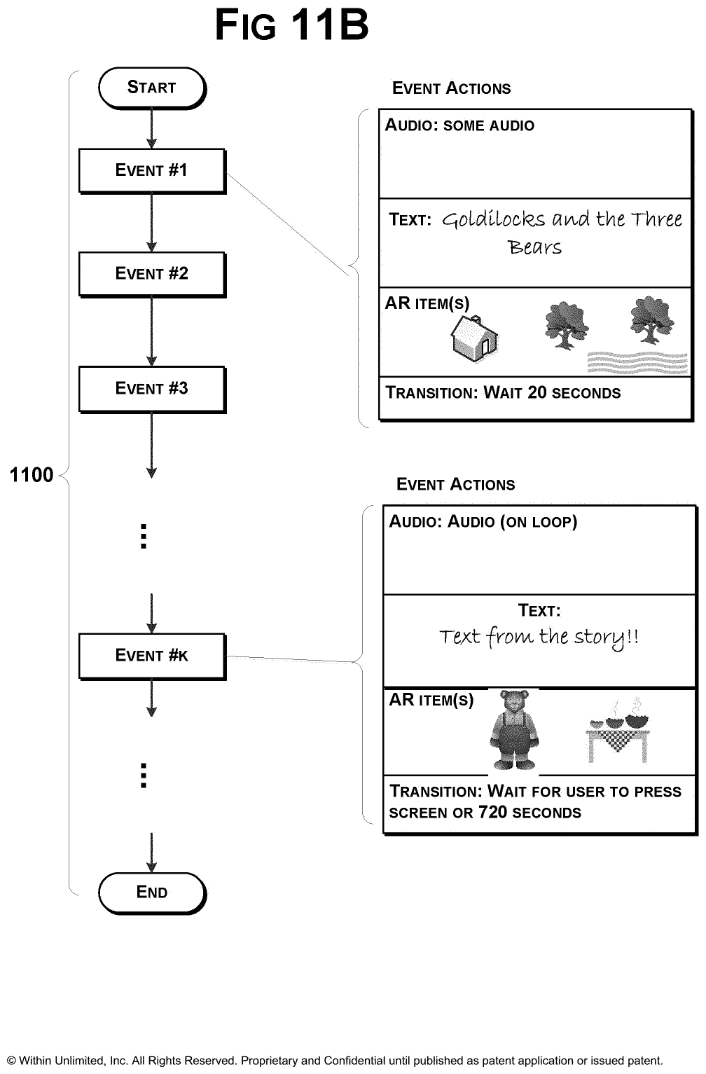

As shown, e.g., in FIG. 11A, a story 1100 may be considered a sequence of events, each event having corresponding event actions 1102 associated therewith. In a normal or default mode, the events occur one after the other. In some modes of the AR story program, a user can control the order of events and select multiple paths through a story. In general, the AR story program starts with the first event and traverses the list of events (possibly under control of a user) until it reaches the last event.

As used herein, the term “story” has its broadest possible meaning, including, without limitation, an account and/or representation of real and/or imaginary events and/or situations and/or people and/or information and/or things. The scope of the invention is not limited by the nature of any story or by its relation to any real or fictitious events or people.

At each event, the AR story program 232 performs the event actions associated with that event. These event actions may include audio actions, text actions, AR items, and transition information or other types of event actions. That is, the event actions may include one or more of: (i) render one or more sounds; (ii) displaying text; and/or (iii) rendering one or more AR items. Other types of event actions may also be included. An event may also provide a transition rule or description that defines the manner in which the next event is started or reached. For example, an event may flow automatically to the next event after a preset period of time (e.g., 15 seconds), or an event may require some form of user interaction (e.g., one or more of: voice command, touch, facial gesture, hand gesture, arm gesture, finger gesture, body gesture, etc.) to go to the next event. These manners of transition or flow control are given only by way of example, and those of ordinary skill in the art will appreciate and understand, upon reading this description, that different and/or other flow controls may be used. The term “voice command” may refer to any sound expected by the AR story program 232, and may include text read by the user. The AR story program 232 may use the text, for example, the text of a story being read by a user may be used to trigger a transition to another event (usually, but not necessarily, the next event in the list).

A story 1100 may transition from one event to another event at different junctions within the story 1100. For instance, an event transition may occur when a new event action is to be performed, such as when new text is to be displayed on the screen, when a new character enters the story, when the setting changes or at any other juncture along the story that may require a new event and new event actions.

In another example, the AR story program 232 may use the front camera 1002 of the exemplary device 1000 to capture gestures (including facial gestures) made by the user during the event flow. As mentioned above, front camera(s) 1002 and rear camera(s) 1008 may both be active simultaneously, with rear camera(s) 1008 capturing the real-world images that may be augmented, and with front camera(s) 1002 capturing images of the user (e.g. gestures that the user may perform). For instance, the storyline may include a character asking the user to point to which road the character should take along a landscape, the left road or the right road. If the user points to the left, the gesture recognition mechanism 252 of the story program 232 may use front camera(s) 1002 to capture and recognize the left-pointing gesture as a transition rule trigger and AR story program 232 may transition to the next event that may involve the character taking the road to the left. If, however the user points to the right, the gesture recognition mechanism 252 of the story program 232 may capture and recognize the right-pointing gesture as a transition rule trigger and AR story program 232 may transition to the next event that may involve the character taking the road to the right. The gesture recognition mechanism(s) 252 may also capture and/or recognize other types of gestures such as a smile that may cross the user's face, a thumbs-up gesture, or any other type of gesture that may be captured and recognized by the AR story program 232 and/or device 1000 as a transition rule or trigger.

It should be noted that in the above example the user controlled the order of events by choosing which road for the character to take (i.e. the left road or the right road). In this case, the sequence of events of story 1100 may not comprise only a linear sequence of events as depicted in the flowchart of FIG. 11A, but may instead include a decision node (not shown) that may lead to two or more distinct paths that the story 1100 may take depending on the user interaction at the particular decision node. In this example, the decision node may lead to two distinct paths, one path that leads the characters down the left road and one path that leads the characters down the right road. Note that this example is meant only for demonstration purposes and that a user may control the transition from one event to the next, as well as the order of the sequence of events, by interacting with the AR story program 232 via other types of interactions, including but not limited to: other types of bodily gestures, voice commands, pressing buttons on device 1000, typing text on the keyboard of device 1000, shaking device 1000, turning device 1000 upside down or in other orientations, or by any other interaction that may be captured and recognized by the AR story program 232 and/or device 1000 as a transition rule or trigger.

For each audio item in an event, the event may specify when the audio is played (e.g., at the start of the event, repeated during the event, etc.). For each text item, the event may specify when and where (on the screen) the text is displayed (e.g., location, format, duration). For each AR item, the event information may specify how and where it is to be displayed and whether or not it is to be animated (e.g., location, format, duration, animation).

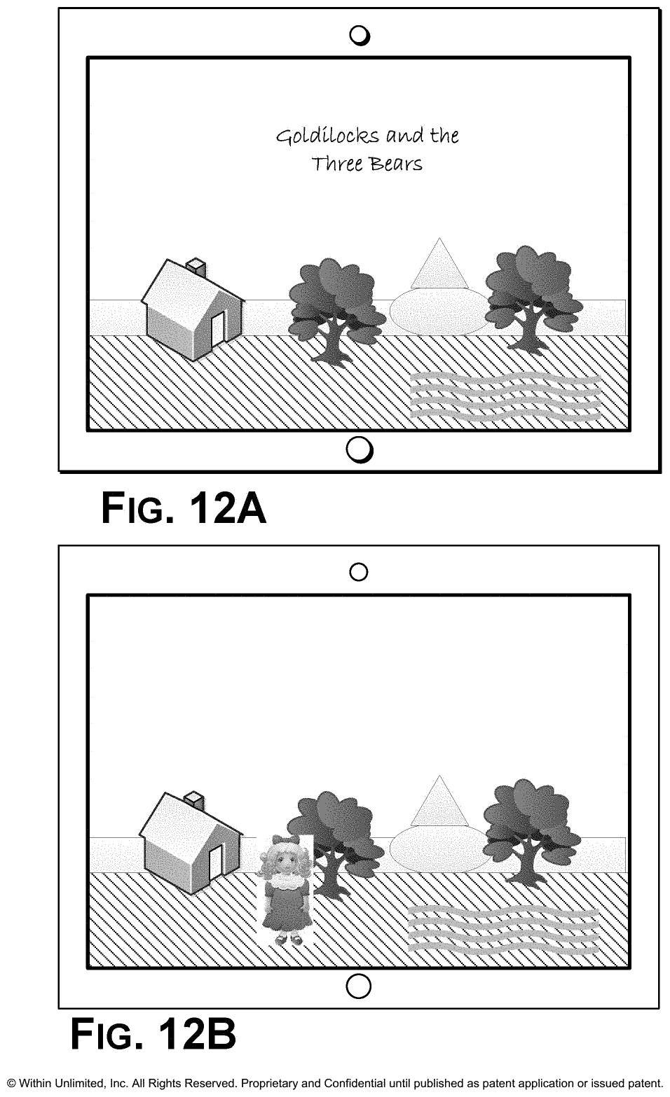

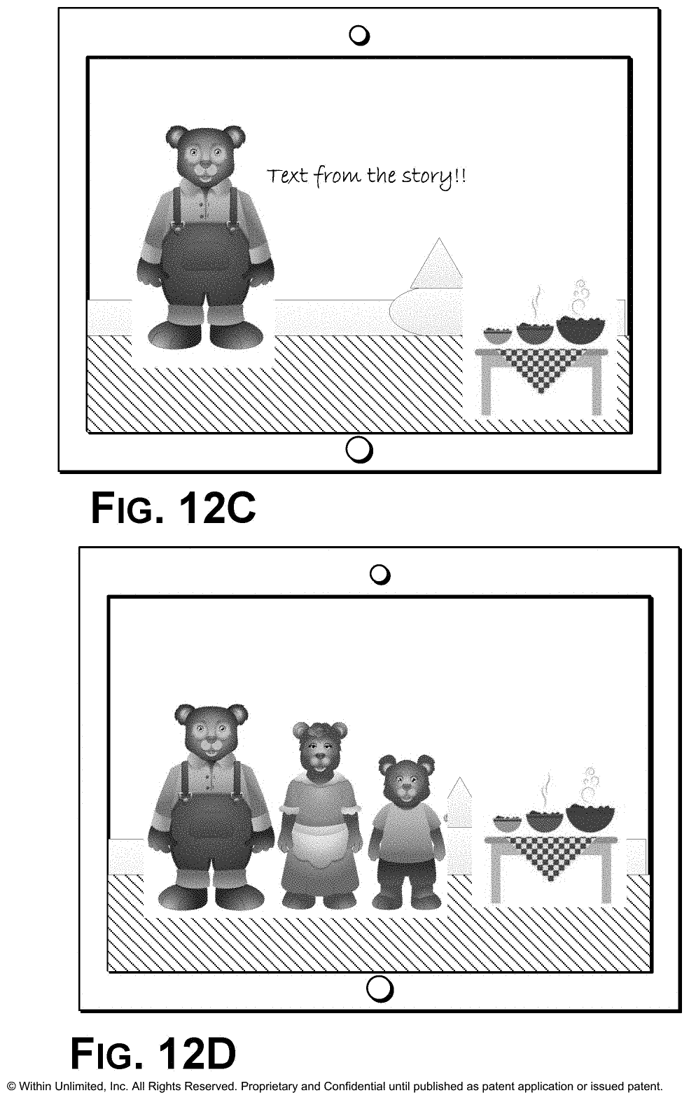

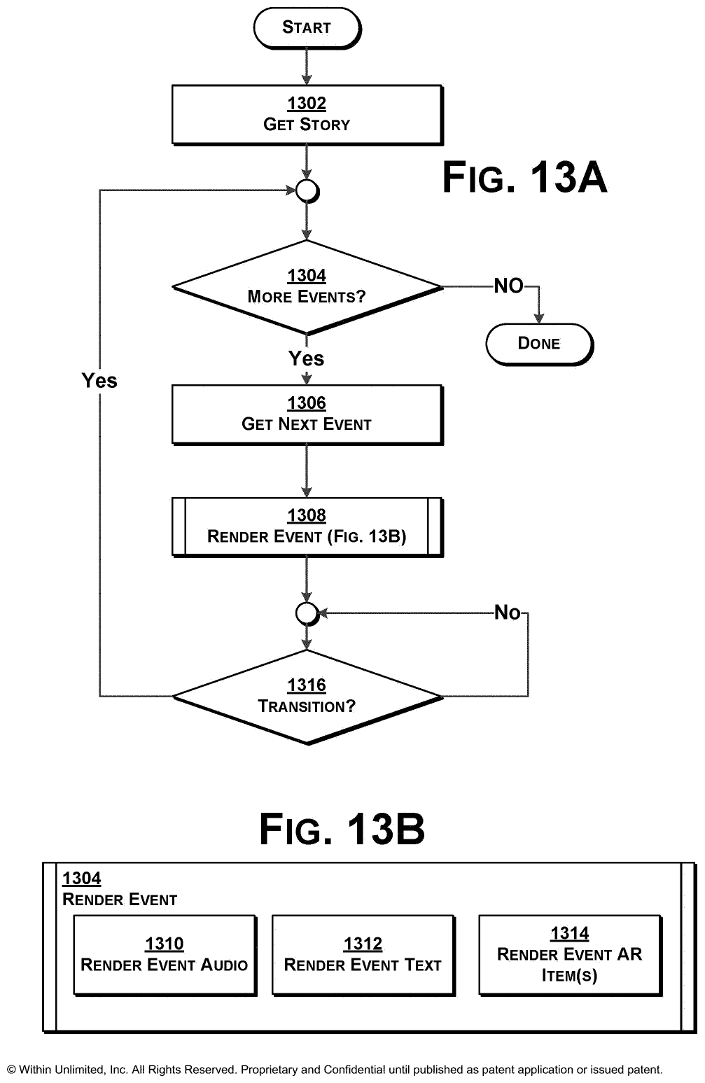

FIG. 11B shows example Event Actions for two different events. The first (for Event #1) corresponds to the display in FIG. 12A, and the second (for Event #k) corresponds to the display in FIG. 12C.

Going back to the example of FIGS. 10A-10B, as the story begins, aspects of the story appear (as augmented reality items) on the user's display. For example, as shown in FIGS. 12A-12E, when the story is about Goldilocks and the Three Bears, aspects of the story may appear as AR items in the display during the story. For example, FIG. 12A may correspond to Event #1 (FIG. 11B), with a house, some trees and a river augmenting the real-world images already in the view. Notably in FIG. 12A, the AR items are shown in conjunction with (on) the real-world image (including, in this example, the objects on the foot of the bed) as then seen by the rear camera 1008.

Next, the user may trigger an event transition rule (e.g. via a voice command, a gesture, or other interaction), and the story 1100 may transition to a new event depending on the trigger interaction. For example, the story 1100 may transition to the event depicted in FIG. 12B, in which an AR item representing a character in the story (e.g., Goldilocks) appears on the screen. The character may be animated. As the story is narrated/traversed, the character on the screen may speak some or all of the words of the story.

The AR Story App 232 may use the microphone(s) 224 and speech or voice recognition mechanism(s) 250 on the device 200 in order to determine whether a particular phrase has been spoken by the user.

FIGS. 12C-12D show other story events, with additional characters from the story represented as AR items and appearing on the screen. Notably, again, the elements/characters from the story that appear on the display are AR items situated in some way in the real-world items in the display.

As noted above, if the device's camera is moved, then the displayed scene, including the AR aspects thereof, will change, preferably in real time. Thus, for example, with the scene depicted in FIG. 12B, if the user changes their position then the corresponding scene may change. For example, a user may change position to be at the foot of the bed, looking toward the head of the bed, in which case they will effectively view the AR scene from that direction. The user may thus look around an AR scene as it is being rendered. The user's movement may include any kind of movement, including moving closer in or further away, thereby effectively zooming into or out of the AR scene. The user may thus, e.g., zoom in on (or out from) any aspect of the AR.

The story may be narrated, at least in part, by a recording (which would be included in the audio part of the event actions), or it may be read or spoken by someone in real time. For example, a parent may read the story (from an external source, e.g., a book or web site or the like) while the AR story App 232 is running. The narrator may pause at times and require interaction (e.g., by touch or voice) before continuing. This approach allows a reader to synch up with the AR animation/activity on the screen (and vice versa). The narrator/reader need not be co-located with the user/device. For example, a parent may read a story to a child over the telephone, with the device running the story app to present the AR version of the story.

In addition, the story 1100 may include different AR characters talking to one another and/or talking to the user. In this case, the characters may generally perform the storyline plot through their actions and dialogue, and/or may talk directly to the user effectively including him/her as another character in the storyline. The interaction with the user may be for pure entertainment purposes or may provide an impetus for the user to perform an event transition trigger as described in the above example.

In some exemplary embodiments, a transition from one event to the next (see FIG. 11B) may be triggered, at least in part, by speaking a word or series of words. The AR Story App 232 may use the microphone(s) 224 and speech or voice recognition mechanism(s) 250 on the device 200 in order to determine whether a particular phrase has been spoken by the user. Note that the speech and voice recognition mechanism(s) 250 may use communications mechanism(s) 240 to access external speech or voice recognition systems (e.g., Google Speech API, Apple Speech API, etc.) in order to supplement their capabilities.

For example, if the script of a story includes the following events (summarized to show transitions):

| | | Text displayed (to | Transition | |
|---|---|---|---|---|
| Event | Description | be read by user) | Trigger | Transition |
| E0 | . . . | . . . | . . . | . . . |
| E1 | Goldilocks is in | “This porridge is | Text is read | Go to event E2 |
| | the kitchen and | too hot.” | with 80% | |
| | tries out first | | accuracy | |
| | bowl of | | | |
| | porridge. | | | |
| E2 | Goldilocks tries | “This porridge is | Text is read | Go to event E3 |
| | second bowl of | too cold.” | with 80% | |
| | porridge | | accuracy | |
| E3 | Goldilocks tries | “This porridge is | Text is read | Go to event E4 |
| | third bowl of | just right.” | with 80% | |
| | porridge | | accuracy | |
| E4 | . . . | . . . | . . . | . . . |

In the example, here 80% reading accuracy is required to transition between events. The degree of reading accuracy required to transition between events may be set to a default value or to different values for different events.

The AR story program 232 may animate or otherwise augment the display of text to be read and text being read. For example, if the text to be read is “Someone has been eating my porridge, and it's all gone!” (which is displayed on the screen of the device), then the individual words may be animated or highlighted or such as they are being read. In some cases, e.g., as an aid to reading, some form of animation (e.g., a pointer or bouncing ball or the like) may be used to show the user which words are to be read next.

While the above example has been given for a particular story, those of ordinary skill in the art will appreciate and understand, upon reading this description, that this story is only an example, and a story played by the AR story program 232 may correspond to any sequence of events. The AR items may correspond to characters or items in the story (e.g., a person, animal, house, tree, etc.) or to a real-world item.

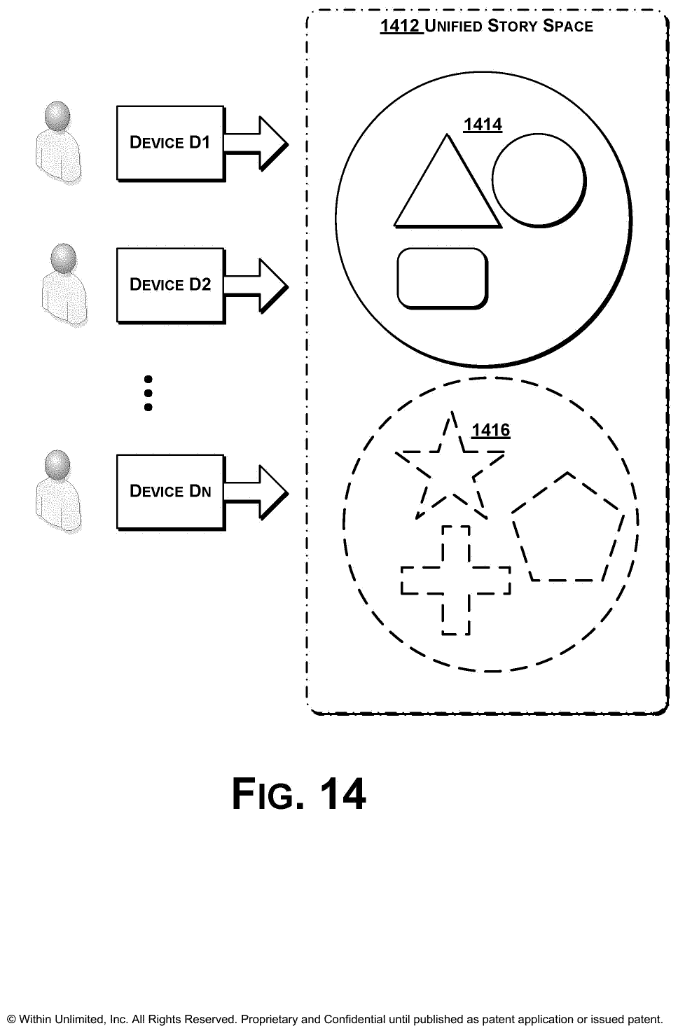

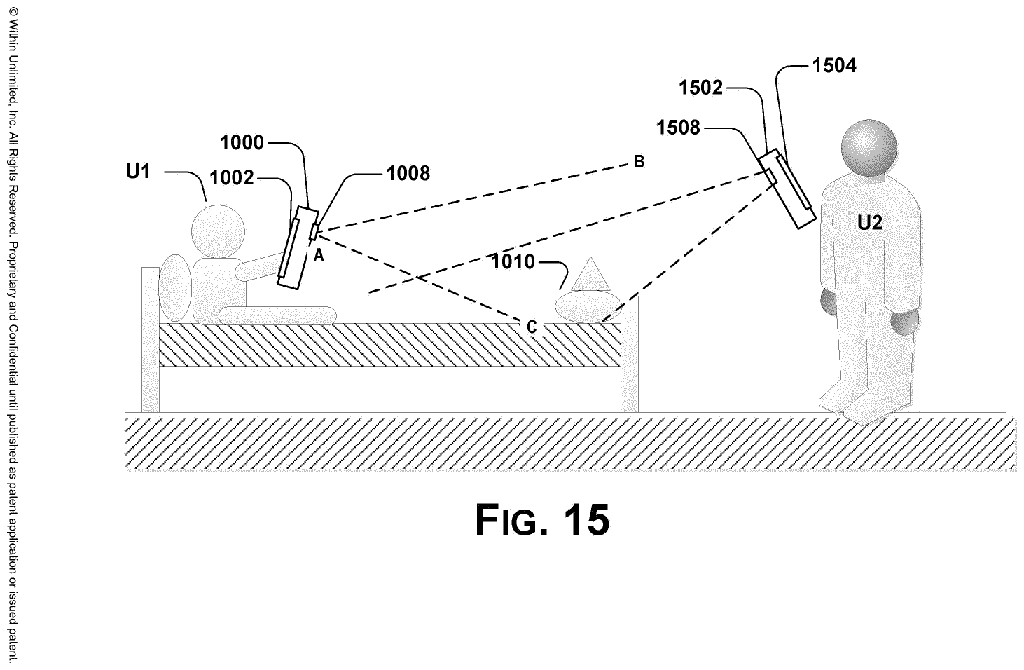

FIGS. 13A-13B shows aspects of exemplary flow of the AR story App 232 on a user's device. Aspects such as setup and other administrative features are not shown.

With reference to the flow diagram in FIG. 13A, when a user starts the AR story program 232, the user selects a story (at 1302). Parts of the story are preferably loaded into the memory to improve the speed of the program. The AR story program 232 then checks (at 1304) if there are more story events. If there are no more events then the story is done. If there are more events then the program gets the next event (at 1306) and renders that event (at 1308).

As used herein, rendering an event means rendering or otherwise playing or displaying the information associated with an event. Thus, as shown in FIG. 13B, rendering an event (at 1308) comprises: rendering the event audio (if any) (at 1310), rendering the event text (if any) (at 1312), and rendering the event AR item(s) (if any) (at 1314). As shown in the drawing in FIG. 13B, the audio, text, and AR item(s) are rendered at the same time, in accordance with their respective descriptions in the event data.

Once the event information is rendered (as described above), the program transitions to the next event (at 1316) in accordance with the event transition information for the event.

Although described above primarily with respect to a single user, the AR story program 232 may be used simultaneously by multiple users. As shown in FIG. 14, the AR story program 232 effectively creates a unified story space 1412, with each user having a view of that space. The real-world objects 1414 may be the objects seen by one particular user (e.g., user U1 in FIG. 10A), or each user may see their own real-world objects (e.g., based on whatever their rear camera is seeing). The virtual (AR) objects 1416 are generated by the story program 232 and may be common to all users (all devices), although, as should be understood, the devices may have different views of the virtual objects.

As should also be appreciated, when multiple devices use the AR story program 232 for the same story (thereby sharing a unified story space), the story flow may be controlled by more than one of the devices. For example, a parent and child in the same location or in different physical or geographic locations may each use their respective device to provide a story. The child's device may provide the primary live real-world view (i.e., the real-world objects 1414) and the AR story program 232 may provide the virtual objects 1416. Each of the child and parent will have a view of the unified story space 1412, update in real time as the story progresses. Alternatively, the parent's device may provide the primary live real-world view.

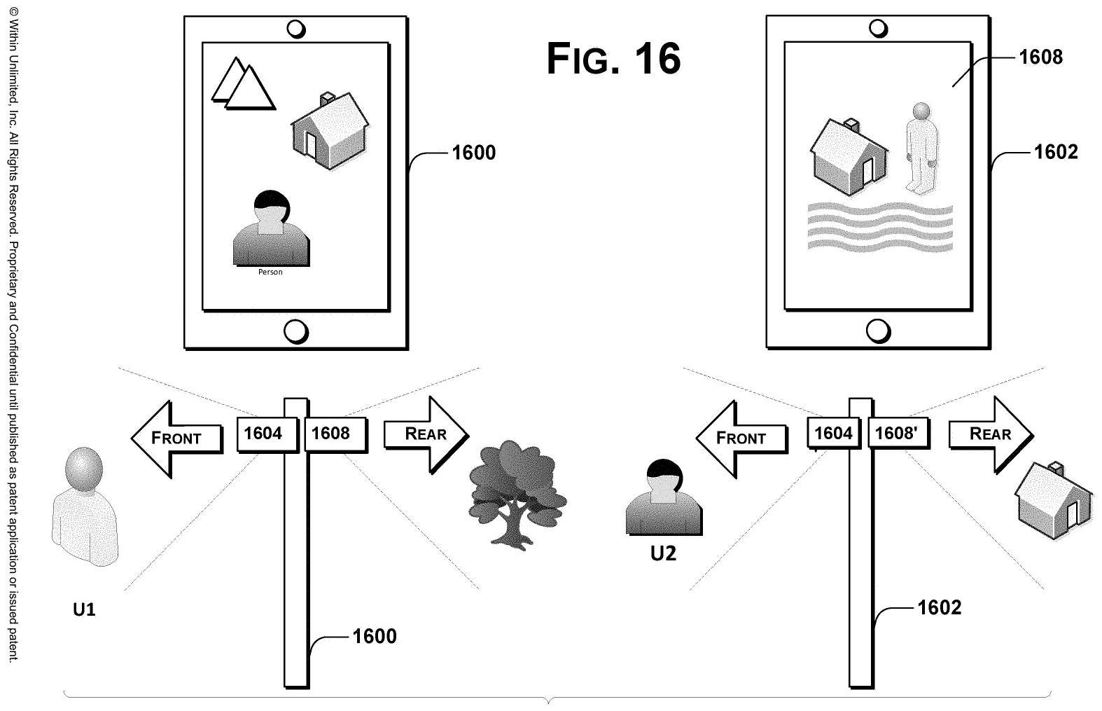

FIG. 15 shows an example of two users (U1 and U2) using the AR story program 232 at the same time. They both view the unified story space, though from different physical locations (in this case, in the same room).

### Example: Stories and Storytelling with Real-Time Augmentation Using the AR App

In another example of the operational aspects of the AR program 232, the experience of the stories and storytelling described above may be embellished by including the functionalities of several additional mechanisms of AR App 232. For example, using his/her device, a user may experience the storytelling AR environment and storyline events provided by the AR App 232 as described in the Stories and Storytelling example in this specification. However, in addition to the mechanisms already engaged by the AR App 232 to perform the storytelling experience, the AR App 232 may also engage its facial recognition mechanism 236, its facial manipulation mechanism 238, its animation mechanism 242 and its augmenter mechanism 234 to modify AR elements of the story and/or to add additional AR elements to the AR story.

For example, the AR App 232 may augment one or more of the characters in the AR story (e.g., the Goldilocks character) with the user's facial expressions in real time.

Using this example, with reference again to FIG. 10A, with both the front and rear cameras of the user's device 1000 active, the rear camera 1008 may capture, in real time, images of the user's immediate environment, and the AR App 232 may augment elements of the storyline (e.g. the Goldilocks character, a house, etc.) into the viewed environment (e.g. on display 1002) as described above in the storytelling example. At the same time, the front camera 1004 may, in real time, capture and store into memory images such as the user U1's face. The AR App 232 may then engage its facial recognition mechanism 236 to determine the portion of the image that represents the user's face, and engage its facial manipulation mechanism 238 to manipulate the images to correspond to the user's perceived facial expressions and/or gestures.

The AR App 232 may then engage its augmenter mechanism 234 to render or otherwise superimpose the manipulated image of the user's face onto a character of the story (e.g., Goldilocks). The augmenter 234 mechanism may also employ the animation mechanism 242 to animate the images prior to or while combining them with the AR images in the AR environment. The result may be a real time view of the character in the AR storyline augmented with an image of the user's face, including the user's real time facial expressions. For example, if the user U1 smiles, the face augmented onto the face of the character may also smile, if the user frowns, the face augmented onto the face of the character may also frown, and so on. As can be appreciated, any other type of facial expression may also be translated from the user to the AR character in real time by this process. Note that it may be preferable for the augmented face of the user, and the user's expressions, to be augmented onto the face of the AR character in such a way that the resulting face appears to be the natural face of the character.

As an extension of this example (or alone), the AR App 232 may also engage its gesture recognition mechanism 252 in order to capture the bodily gestures of a user, e.g., as captured by the front camera 1002 (FIG. 10A). The bodily gestures of the user may then be manipulated by the gesture manipulation mechanism 254 to manipulate the images to correspond to the user's bodily gestures. The animation mechanism 242 may then be engaged to animate the images of the bodily gestures and the augmenter mechanism 234 may augment the gesture images onto the body of the character within the AR environment in real time. The result may be the AR character (e.g. Goldilocks) performing the same bodily gestures as the user may be performing in real time. For example, if the user raises his/her hands above their head, the character may also raise their hands above their head. If the user gives the thumbs up sign with their hand, the character may also give the thumbs up sign with their hand. It can be appreciated that any other bodily gesture performed by the user may be captured and augmented into the AR environment as a bodily gesture performed by the body of the AR character. Note that it may be preferable for the augmented bodily gestures of the AR character to be augmented in such a way that their performance by the AR character's body may seem as a natural bodily gesture.

It can be appreciated that the other functionalities and flows of the storytelling program (AR App 232) as described in the storytelling example in other areas of this specification may also apply to this example. For instance, the event flow depicted in FIGS. 13A-13B with relation to the storytelling example may also apply to this example, and therefore need not be repeated here.

Note that if multiple users are viewing the same story on their individual devices 1000 collectively or as collaboration (e.g., as shown in FIG. 15), that the facial expressions or gestures of more than one user may be mapped onto the characters of the AR story. For example, as depicted in FIG. 15, user U1 may use device 1000 with front camera 1002 and back camera 1008, and user U2 may use device 1502 with front camera 1504 and back camera 1508, and each may view the same storyline and the same (or different) real world objects. In this example, the first user's facial expressions and bodily gestures may be mapped onto a first AR character (such as Goldilocks) and a second user's facial expressions and bodily gestures may be mapped onto a second AR character (such as the Papa Bear). In this scenario, the AR App 232 may engage the communications mechanism 240 so that the users may all view the same AR story experience with the characters augmented with the respective users' facial expressions and bodily gestures.

Note also that a first user's facial expressions may be mapped onto a first AR character, and the first user's bodily expressions may be mapped onto a second AR character. Using the example above with multiple users on multiple devices, Goldilocks may perform the first user's facial expressions and the second user's bodily gestures, and Papa Bear may perform the second user's facial expressions and the first user's bodily gestures. It can be appreciated that any combination thereof, as well as any combination that may include additional AR characters and/or additional users may also be provided.

Similarly, each user's voice (possibly augmented, e.g., using speech or voice augmentation mechanism(s) 248) may be associated with and mapped onto a particular story character. Thus, e.g., a particular user (e.g., a father) may be associated with an AR character (such as the Papa Bear) such that the father's facial expressions and/or bodily gestures are mirrored by the AR character, and the father's voice is reproduced, possibly augmented, by the AR character. This approach may be more useful or effective when the users are not in the same location.

It should also be noted that this functionality may not necessarily require for the AR characters to be a part of a story as described in the Storytelling with AR App 232 example. For example, the users' may portray themselves as avatars or as other types of representations of themselves within the AR environment. If multiple users are experiencing the AR environment simultaneously, then each user may view the other users within the AR environment augmented with each user's respective facial expressions and/or bodily gestures. Also, as with the example above, the facial expressions of one user may be mapped onto a first representation while the bodily gestures of the same user may be mapped onto a second representation within the AR environment. It should be appreciated that any combination thereof may also be provided by AR App 232.

In this manner, users may effectively animate their corresponding representations (e.g., avatars) in the shared and unified virtual space.

### Example: The Device as an AR Object Using the AR App

In other exemplary functionality of embodiments of the AR program 232, a user's device may be associated with a virtual character or object in the virtual space. In such case, movement of the user's device may be used to animate the corresponding virtual character or object.

For example, a user may have a device (corresponding to device 200 in FIG. 2A) running a version of the AR story program 232. The user may hold the device such that he/she may view the device's display and the device's rear camera may capture a view of the user's immediate environment (e.g., shown in FIG. 10A as the dashed lines AB and AC). In addition, the AR App 232 may deliver an AR storyline with storyline events into the view as presented on the device's display such that the view may include real world objects within the immediate environment of the user augmented with the virtual objects and characters of the AR storyline.

In these exemplary embodiments, the AR App 232 may engage one or more of the device's sensors 228 (FIG. 2A) such as a gyroscope and an accelerometer. For example, the gyroscope may be used to measure the rate of rotation of the device around a particular axis, and may thereby be used to determine the orientation of the device. The accelerometer may measure the linear acceleration of the device. By using these two sensors in combination, the AR App 232 may map the device itself (and its movement) into the AR environment.

In these exemplary embodiments, the AR App 232 may augment the AR environment by placing a virtual object corresponding to the device into the AR environment represented as a virtual object. The virtual object may be superimposed into the hand of an AR character (so that it may appear that the character is holding the object), or it may be free standing as a standalone virtual object (e.g., a first-person object, cursor, etc.), or it may be placed in combination with other virtual or other real-world objects, or any combination thereof.

In an example, the user may physically move their device with their hands (up and down, side to side, rotate it, or induce any other type of physical motion or movement onto the device), and the corresponding virtual object within the AR environment may follow a similar motion or movement within the view on the device.

Note that the device may be mapped into the AR environment as any type of virtual object, including a virtual character (or avatar) or onto any combination of virtual objects. In the case of a multi-user interaction, a user's device may thus be seen by the other users in the AR environment as a virtual object.

Note that the examples described above are only for demonstrational purposes and do not limit the scope of the current invention to only those examples listed. As such, it will be immediately appreciated by a person of ordinary skill in the art that the AR App 232 may represent the device as a virtual object of any type of form, including the form of the device itself.

In addition, the AR App 232 may employ the native controls of the device and use them to allow the user to operate the virtual object as it is displayed in the AR environment.

In addition, it may be possible for more than one user to participate in the AR environment of this example. By adding and/or combining other mechanisms of AR App 232 and functionalities described in other examples in this specification (e.g. the communications mechanism 240) additional participants with additional devices may also participate.

### Example: AR View Sharing Using the AR App

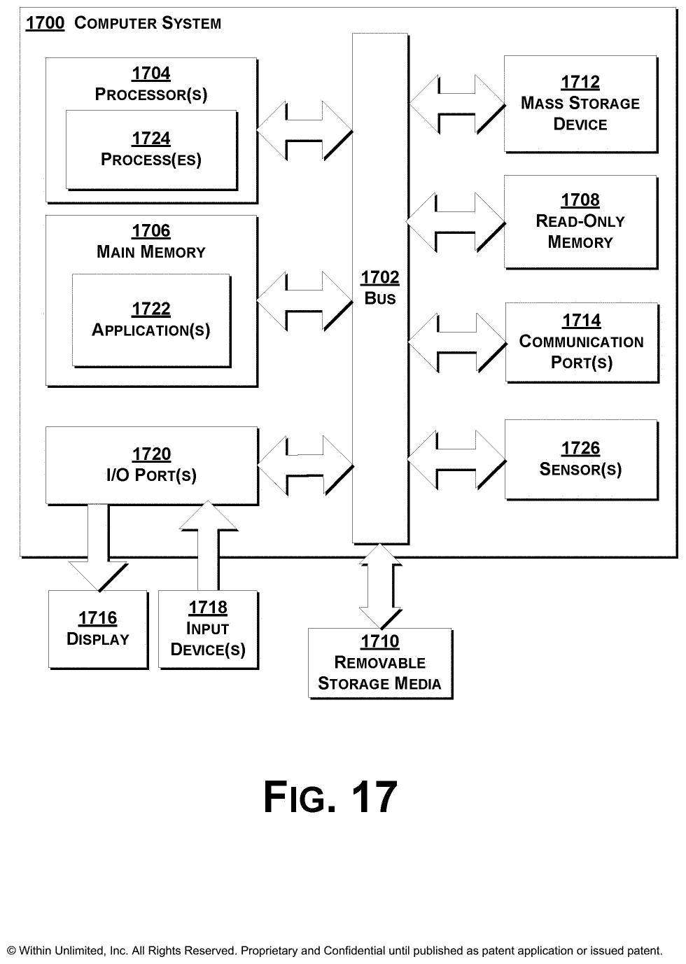

In other exemplary functionality of embodiments of the AR program 232, e.g., as shown in FIG. 16, a first user U1 may have a first device 1600 (corresponding to device 200 in FIG. 2A) running a version of the AR program 232 on the first device, and a second user U2 may have a second device 1602 (also corresponding to device 200 in FIG. 2A), also running a version of the AR program 232 on the second device. Using the AR program, users U1 and U2 may be in communication with each other (e.g., via a cellular network, a LAN, a WAN, a satellite connection, etc.).

In this example, both user U1 and user U2 may view the same or similar AR environment on each of their respective devices as shown in FIG. 16. In particular, the viewed AR environment may be an augmented view of the real-world environment captured by either device 1600 or device 1602. In the example depicted in FIG. 16, the rear camera 1608 of U1's device 1600 may capture real-time images of U1's real world environment and augment them accordingly, and both users U1 and U2 may each view the resulting AR environment on each of their respective devices 1600, 1602. The device 1600 may be referred to as the primary device since the images it may capture on its rear camera 1608 may be viewed by both devices 1600, 1602.

Note however that device 1602 may also be considered a primary device, such that both devices 1600, 1602 may instead view the images captured by its rear camera 1608′. In addition, an extension of this example may be that both devices 1600, 1602 may be primary devices and the AR view may be a combination of augmented views captured by both rear cameras 1608, 1608′ from both devices 1600, 1602.

Although this example shows only two users/devices, it should be appreciated that multiple users/devices may participate in the viewing of the shared AR environment and any one or more of the user's devices may be primary devices.

In this example, the rear camera 1608 of U1's device 1600 may continuously capture images of U1's immediate environment and both users U1 and U2 may view the images in real time. Note that the images may or may not be augmented with virtual images or information as described in any of the other examples presented herein. The first user U1 may physically move from one location to another location within their real-world environment (e.g., the user U1 may walk around) and their device 1600 may continue to capture and save to memory the changing images of the view as he/she moves. As user U1 may continuously move within their environment while capturing and storing the real-world view, the AR App 232 may create and map a 2-D or, preferably, a 3-D model of user U1's real world environment (e.g. using 2-D and 3-D modeling mechanism 244) on his/her device 1600.

To accomplish this, the AR App 232 on U1's device 1600 may employ the device's various sensors 228 (such as an accelerometer and a gyroscope), as well as the device's GPS module 229. By recording the device's location (via the GPS module 229), the devices orientation (e.g., via the gyroscope) and the device's movement (e.g., via the accelerometer), and correlating this data with the real-time captured images of the environment, the AR App 232 may map the captured views with the location, orientation and movement information to create a 2-D or, preferably, a 3-D model of the environment as viewed by user U1. The 2-D and 3-D modeling mechanism 244 may include modeling algorithms and software necessary to create the model of the environment utilizing that various data captured by the device 1600 and/or the AR App 232. It can be seen that as user U1 may continue to move about within his/her environment while continuously capturing additional data, the 2-D or 3-D model of his/her environment may become more robust, comprehensive and filled with more details of the environment.

Note that virtual objects, characters or other forms may also be augmented into the environment and included in the model described above for each participant to view and experience on their respective devices 1600, 1602. The virtual forms may be static, dynamic, moving or any combination thereof. In this way, each user may experience a fully augmented AR environment from their own unique perspective.

As the model of the environment is created by AR App 232, the App 232 may continuously communicate model data to user U2's device 1602. In this way, user U2 may also view the modeled environment. In addition, because the model may include mapped 2-D or 3-D data, the user U2 may also move about the modeled environment by physically moving. That is, the user U2 may physically move in his/her own environment, and simultaneously, as viewed on his/her device 1602, may correspondingly move about in the mapped 2-D or 3-D model of the user U1's environment.

To accomplish this, the AR App 232 on the user U2's device 1602 may also engage its device's sensors 228 (e.g. an accelerometer, a gyroscope, etc.) and its device's GPS system 229. In this way, the AR App 232 may determine the physical location of the user U2 within his/her real-world environment, and may then map this location to a virtual location within the modeled 3-D environment. Then, when the user U2 may physically move within his/her real-world environment, the AR App 232 may calculate the exact direction, distance and other aspects of U2's movement relative to his/her prior location. Equipped with this data, the AR App 232 may correlate the movement with the 3-D model and map the movement within the modeled environment. The AR App 232 may then apply the data to the view as seen by user U2 on his/her device 1602 so that the resulting view may represent the movement within the AR environment.

For example, the user U2 may physically take a step forward in their real-world environment, and simultaneously experience a forward step in the AR environment as viewed on their device 1602. Expanding upon this example, consider that the real-world environment of the user U1 may include a house, and the house may thusly be viewed by both users U1 and U2 on their respective devices 1600, 1602 (FIG. 16). The user U1 may walk around the house while recording images of the house that are then mapped to a 3-D model of the house and its environment. The model may be communicated to user U2's device in real time such that the user U2 may view the 3-D model of the house and its environment on the display of their device 1602. The user U2 may then physically walk in their real-world environment while simultaneously viewing themselves moving in a correspondingly similar fashion within the modeled AR environment as viewed on their device 1602. That is, the user U2 may also walk around the house and view it independently of user U1. To depict this, note that the perspective of the house on the display of U2's device 1602 may be a different perspective of the house compared to the house displayed on U1's device 1600.

It should be noted that the user U2's experience may not rely on the real-time view of the user U1's camera(s), but instead may rely on the modeled data and the coordinates and movements of the user U2 as described above. In this way, using the example presented, the user U1 may be on one side of the house and the user U2 may be on an opposite side of the house and each user may view their respective (and different) views of the environment.

### End of Examples

While the exemplary embodiments have been described with respect to a device such as a smartphone or a tablet computer or the like, those of ordinary skill in the art will appreciate and understand, upon reading this description, that different and/or other devices may be used. For example, in some embodiments, the cameras may not be in the same device. Furthermore, in some embodiments, the device may be an AR glasses or the like with one or more front-facing cameras.

In some other exemplary embodiments, the rear view may be obtained by direct viewing. For example, in embodiments in which the device is incorporated (fully or partially) into AR glasses, the user may view the scene (in front of them) without the use of (or need for) a rear-facing camera to capture the environment. In such embodiments, the user's eyes effectively act as a rear-facing camera (facing away from the user), and a rear-facing camera is not needed, although one may be used, e.g., to supplement or record the user's view. In such embodiments, the device 200 may exclude rear camera(s) 212.

In such embodiments, a hypothetical avatar may be animated over the live environment seen through the AR glasses lens. One or more front facing cameras may capture the user's facial expressions and map them onto the avatar. When the user is wearing the device (e.g., a VR headset or AR glasses), the user's expression may be determined, e.g., using one or more cameras looking at the user's eyes and/or mouth and/or facial muscle sensing.

### Computing

The applications, services, mechanisms, operations, and acts shown and described above are implemented, at least in part, by software running on one or more computers.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

FIG. 17 is a schematic diagram of a computer system 1700 upon which embodiments of the present disclosure may be implemented and carried out.

According to the present example, the computer system 1700 includes a bus 1702 (i.e., interconnect), one or more processors 1704, a main memory 1706, read-only memory 1708, removable storage media 1710, mass storage 1712, and one or more communications ports 1714. Communication port(s) 1714 may be connected to one or more networks (not shown) by way of which the computer system 1700 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 1704 can be any known processor, such as, but not limited to, an Intel® Itanium® or Itanium 2® processor(s), AMD® Opteron® or Athlon MP® processor(s), or Motorola® lines of processors, and the like. Communications port(s) 1714 can be any of an Ethernet port, a Gigabit port using copper or fiber, or a USB port, and the like. Communications port(s) 1714 may be chosen depending on a network such as a Local Area Network (LAN), a Wide Area Network (WAN), or any network to which the computer system 1700 connects. The computer system 1700 may be in communication with peripheral devices (e.g., display screen 1716, input device(s) 1718) via Input/Output (I/O) port 1720.

Main memory 1706 can be Random Access Memory (RAM), or any other dynamic storage device(s) commonly known in the art. Read-only memory (ROM) 1708 can be any static storage device(s) such as Programmable Read-Only Memory (PROM) chips for storing static information such as instructions for processor(s) 1704. Mass storage 1712 can be used to store information and instructions. For example, hard disk drives, an optical disc, an array of disks such as Redundant Array of Independent Disks (RAID), or any other mass storage devices may be used.

Bus 1702 communicatively couples processor(s) 1704 with the other memory, storage and communications blocks. Bus 1702 can be a PCI/PCI-X, SCSI, a Universal Serial Bus (USB) based system bus (or other) depending on the storage devices used, and the like. Removable storage media 1710 can be any kind of external storage, including hard-drives, floppy drives, USB drives, Compact Disc-Read Only Memory (CD-ROM), Compact Disc-Re-Writable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random-access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements which are appropriate to perform the methods.

As shown, main memory 1706 is encoded with application(s) 1722 that support(s) the functionality as discussed herein (the application(s) 1722 may be an application(s) that provides some or all of the functionality of the services/mechanisms described herein, e.g., AR story application 232, FIG. 2A). Application(s) 1722 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 1704 accesses main memory 1706 via the use of bus 1702 in order to launch, run, execute, interpret or otherwise perform the logic instructions of the application(s) 1722. Execution of application(s) 1722 produces processing functionality of the service related to the application(s). In other words, the process(es) 1724 represent one or more portions of the application(s) 1722 performing within or upon the processor(s) 1704 in the computer system 1700.

For example, process(es) 1704 may include an AR application process corresponding to AR application 232.

It should be noted that, in addition to the process(es) 1724 that carries(carry) out operations as discussed herein, other embodiments herein include the application 1722 itself (i.e., the un-executed or non-performing logic instructions and/or data). The application 1722 may be stored on a computer readable medium (e.g., a repository) such as a disk or in an optical medium. According to other embodiments, the application 1722 can also be stored in a memory type system such as in firmware, read only memory (ROM), or, as in this example, as executable code within the main memory 1706 (e.g., within Random Access Memory or RAM). For example, application(s) 1722 may also be stored in removable storage media 1710, read-only memory 1708, and/or mass storage device 1712.

Those skilled in the art will understand that the computer system 1700 can include other processes and/or software and hardware components, such as an operating system that controls allocation and use of hardware resources. For example, as shown in FIG. 18, the computer system 1700 may include one or more sensors 1726 (see sensors 228 in FIG. 2A).

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

Although embodiments hereof are described using an integrated device (e.g., a smartphone), those of ordinary skill in the art will appreciate and understand, upon reading this description, that the approaches described herein may be used on any computing device that includes a display and at least one camera that can capture a real-time video image of a user. For example, the system may be integrated into a heads-up display of a car or the like. In such cases, the rear camera may be omitted.

### CONCLUSION

As used herein, including in the claims, the phrase “at least some” means “one or more,” and includes the case of only one. Thus, e.g., the phrase “at least some ABCs” means “one or more ABCs”, and includes the case of only one ABC.

The term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X”. In the context of a conversation, the term “portion” means some or all of the conversation.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

As used herein, including in the claims, the phrase “corresponds to” means “corresponds in part to” or “corresponds, at least in part, to,” and is not exclusive. Thus, e.g., the phrase “corresponds to factor X” means “corresponds in part to factor X” or “corresponds, at least in part, to factor X.” Unless specifically stated by use of the word “only,” the phrase “corresponds to X” does not mean “corresponds only to X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components.

The present invention also covers the exact terms, features, values and ranges etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” and the like, is merely intended to better illustrate the invention and does not indicate a limitation on the scope of the invention unless so claimed. Any steps described in the specification may be performed in any order or simultaneously, unless the context clearly indicates otherwise.

All of the features and/or steps disclosed in the specification can be combined in any combination, except for combinations where at least some of the features and/or steps are mutually exclusive. In particular, preferred features of the invention are applicable to all aspects of the invention and may be used in any combination.

Reference numerals have just been referred to for reasons of quicker understanding and are not intended to limit the scope of the present invention in any manner.

Thus, is provided an augmented reality system that combines a live view of a real-world, physical environment with imagery based on live images from one or more other devices.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

We claim:

1. A method, with a device having at least one camera and a display, the method comprising:
(A) capturing a scene with said at least one camera, the scene comprising a live view of a real-world physical environment; and
(B) for a story comprising a plurality of events,
(B)(1) rendering a particular event of said plurality of events on said display, wherein said rendering of said particular event augments the scene captured in (A) by said at least one camera.

2. The method of claim 1, further comprising:
(B)(2) transitioning to a next event of said plurality of events; and,
(B)(3) in response to said transitioning in (B)(2), rendering said next event of said plurality of events on said display.

3. The method of claim 2, wherein said particular event includes event transition information, and wherein said transitioning in (B)(2) occurs in accordance with said event transition information.

4. The method of claim 1, wherein said transition is based on one or more of:
(a) a period of time;
(b) a user interaction; and
(c) a user gesture.

5. The method of claim 4, wherein the user gesture is determined based on one or more of: (i) an image obtained by said device; and (ii) on movement and/or orientation of said device.

6. The method of claim 4, wherein the user gesture comprises a facial gesture and/or a body gesture.

7. The method of claim 4, wherein the user interaction comprises one or more of: a user voice command; and a user touching a screen or button on said device.

8. The method of claim 1, wherein said particular event comprises one or more of: (i) audio information; (ii) textual information; and (iii) augmented reality (AR) information, and wherein rendering of said particular event in (B)(1) comprises rendering one or more of: (x) audio information associated with said event; (y) textual information associated with said event; and (z) AR information associated with said event.

9. The method of claim 1, further comprising:
repeating act (B)(1) for multiple events in said story.

10. The method of claim 1, wherein the at least one camera and the display are integrated in the device.

11. The method of claim 1, wherein the device is a mobile phone or a tablet device.

12. The method of claim 1, further comprising:
(C) obtaining a user image from at least one second camera; and
(D) rendering, on said display, a version of the user image with the particular event of said plurality of events in (B)(1).

13. The method of claim 12, wherein rendering a version of the user image in (D) comprises:
animating at least a portion of the user image.

14. The method of claim 13, wherein the portion of the image comprises the user's face.

15. The method of claim 12, further comprising:
recognizing the user's face in the user image.

16. The method of claim 14, further comprising:
tracking the user's face in real-time.

17. The method of claim 12, wherein the rendering in (C) is based on real time tracking of the user's face in the user image.

18. The method of claim 13,
wherein said at least one second camera is associated with a second device, and
wherein said animating is based, at least in part, on manipulation and/or movement of the second device.

19. The method of claim 18, wherein the second device comprises a mobile phone or a tablet device.

20. The method of claim 1, further comprising:
(E) capturing audio data from said device; and
(F) rendering a version of the captured audio with the particular event of said plurality of events in (B)(1) on at least one speaker associated with said device.

21. The method of claim 20, wherein the audio rendered in (F) is manipulated and/or augmented before being rendered.

22. The method of claim 12, wherein the at least one second camera is associated with said device.

23. The method of claim 12, wherein the at least one second camera is associated with another device, distinct from said device.

24. The method of claim 2, wherein said transitioning in (B)(2) is based on an action associated with another device.

25. The method of claim 24, wherein said transitioning in (B)(2) is triggered by said action associated with said other device.

26. A method comprising:
(A) capturing a scene from a first camera associated with a first device having a first display, the scene comprising a live view of a real-world physical environment;
(B) for a story comprising a plurality of events,
(B)(1) rendering a particular event of said plurality of events on said first display, wherein said rendering of said event augments the scene captured by said first camera; and
(B)(2) transitioning to a next event of said plurality of events.

27. The method of claim 26, wherein said rendering of said event also augments the scene with information associated with at least one other device.

28. The method of claim 27, wherein said information associated with said at least one other device corresponds to on one or more of:
(i) an image captured by said at least one other device; and
(ii) an image representing or corresponding to said at least one other device.

29. The method of claim 27, wherein said information associated with said at least one other device corresponds to on one or more of:
(iii) audio from said at least one other device.

30. The method of claim 28, wherein said image representing or corresponding to said at least one other device comprises an avatar.

31. The method of claim 28, wherein said image representing or corresponding to said at least one other device is animated.

32. The method of claim 31, wherein said image is animated, at least in part, by manipulation and/or movement of the at least one other device.

33. The method of claim 26, wherein said particular event includes event transition information, and wherein said transitioning in (B)(2) occurs in accordance with said event transition information.

34. The method of claim 27, wherein said transitioning in (B)(2) occurs based on an action associated with said at least one other device.

35. The method of claim 34, wherein said transitioning in (B)(2) is triggered by said action associated with said other device.

36. The method of claim 26, wherein the captured scene comprises a unified space, and wherein the rendered particular event provides a view of the unified space.

37. A communication method comprising:
(A) obtaining a plurality of images from a first camera associated with a first device, said plurality of images comprising live views of a first real-world, physical environment;
(B) using the plurality of images to create a modeled space of the first real-world physical environment;
(C) providing said modeled space to a second device in communication with the first device; and
(D) correlating a real-world location of a user of said second device with a corresponding virtual location within the modeled space,
wherein changes in the real-world location of the user of said second device result in corresponding changes of the virtual location within the modeled space.

38. A communication method comprising:
(A) obtaining a first image from a first camera associated with a first device, said first image comprising live view of a first real-world, physical environment;
(B) for each particular second device of one or more second devices,
(b)(1) obtaining, from said particular second device, a particular second image, said particular second image being based on a live view of a user of the particular second device;
(C) creating an augmented image based on (i) the first image, and (ii) at least one particular second image obtained in (B); and
(D) rendering the augmented image on a display associated with the first device.

39. A communication method comprising:
(A) obtaining a first image from a first camera associated with a first device, said first image comprising live view of a first real-world, physical environment;
(B) obtaining a second image from a second device in communication with said first device, said second image being based on a real view of a user of the second device;
(C) creating an augmented image based on the first image and the second image; and
(D) rendering the augmented image on a display associated with the first device.
